(19) United States
(12) Patent Application Publication
(10) Pub. No.: US 2004/0212843 A1
(43) Pub. Date: Oct. 28, 2004

(54) Image processing method, image processing apparatus, electronic camera and computer-readable storage medium

(76) Inventors: Taku Kodama, Kanagawa (JP); Takao Inoue, Kanagawa (JP); Akira Takahashi, Kanagawa (JP); Shin Aoki, Kanagawa (JP); Keiichi Ikebe, Kanagawa (JP); Takanori Yano, Kanagawa (JP); Takeshi Koyama, Tokyo (JP); Hiroyuki Sakuyama, Tokyo (JP); Ikuko Yamashiro, Kanagawa (JP); Takashi Maki, Kanagawa (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/761,910

(22) Filed: Jan. 20, 2004

(30) Foreign Application Priority Data
Jan. 20, 2003 (JP) 2003-011683

(51) Int. Cl. H04N 1/41

(52) U.S. Cl. 358/426.01

(57) ABSTRACT

An image processing method carries out a compression process which divides an image into a plurality of divided regions and compresses the divided regions in a state where each of the divided regions are independent of one another, and sets boundaries of the divided regions in order to approximately match boundaries of one or a plurality of image regions which are within the image and have aspect ratios and/or sizes different from those of the image.

The present application claims priority to the corresponding Japanese Application No. 2003-011683 filed on Jan. 20, 2003, the entire contents of which are hereby incorporated by reference.

### BACKGROUND OF THE INVENTION

1. Field of the Invention

The present invention generally relates to, and more particularly to image processing methods, image processing apparatuses, electronic cameras and computer-readable storage media, and more particularly to an image processing method, an image processing apparatus and an electronic camera which employ an image compression process, and to a computer-readable storage medium which stores a program for causing a computer to carry out an image compression process.

2. Description of the Related Art

Generally, images are stored or transmitted in a state where the images are compressed. The JPEG is popularly used for the still image compression, and the MPEG is popularly used for the dynamic image compression.

Image display screens of electronic equipments such as personal computers, portable information terminals, portable telephone sets and the like have various aspect ratios, that is, various vertical and horizontal sizes. When reading encoded data of an image that has been compressed according to the JPEG or MPEG from a recording medium via a network and displaying the read data on such electronic equipment, the aspect ratio and/or size of the image display screen may be different from the aspect ratio and/or size of the original image. In this case, the encoded data is expanded back to the original image, and a required region of the original image is extracted and subjected to a reduction or enlargement. Such an image processing method is proposed in a Japanese Laid-Open Patent Application No.2001-228857, for example, and will hereinafter be referred to as a “first method.”

In order to eliminate the need to carry out the above-described processes required by the first method, it is possible to prepare, at the image transmitting end, the encoded data of a plurality of images having different aspect ratios and/or sizes. At the receiving end, the encoded data corresponding to the aspect ratio and/or size of the image display screen is selected. Such an image processing method is proposed in Yasuyuki Nomizu, “Next-Generation Image Coding Method JPEG2000,” Ticeps, Feb. 13, 2001, and will hereinafter be referred to as a “second method.”

The JPEG2000 (ISO/IEC FCD 15444-1) and the Motion-JPEG2000 (ISO/IEC FCD 15444-3), which is an extension thereof, are viewed as promising image compression techniques that may replace the JPEG or MPEG. The JPEG2000 is also described in Yasuyuki Nomizu, “Next-Generation Image Coding Method JPEG2000,” Ticeps, Feb. 13, 2001. The Motion-JPEG2000 treats a plurality of time-sequential still images as frames to treat a dynamic image, but each individual frame is compressed according to the compression algorithm of the JPEG2000.

The first method described above requires additional processes to be performed at the receiving end (or image displaying end), such as extraction of the image from the original image and reduction or enlargement of the extracted image. The need for extraction from the original image and reduction or enlargement of the extracted image, means that, the amount of codes in the received encoded data is greater than the amount of codes that is actually required. Consequently, it takes additional time to carry out the reception process and the expansion process with respect to the encoded data.

On the other hand, the second method described above creates and stores the plurality of encoded data with respect to the same image, at the transmitting end. As a result, the cost of the transmitting end increases due to the need to create and store the plurality of encoded data for the same image.

### SUMMARY OF THE INVENTION

An image processing method, image processing apparatus, electronic camera and computer-readable storage medium are described. In one embodiment, the image processing method comprises carrying out a compression process that divides an image into a plurality of divided regions and compresses the divided regions in a state where each of the divided regions are independent of one another; and setting boundaries of the divided regions in order to approximately match boundaries of one or a plurality of image regions which are within the image and have aspect ratios and/or sizes different from those of the image.

### BRIEF DESCRIPTION OF THE DRAWINGS

FIG. 1 is a system block diagram for illustrating basic compression and expansion algorithms of the JPEG2000;

FIG. 2 is a diagram showing a format of encoded data generated according to the JPEG2000;

FIG. 3 is a diagram showing a tile image before a two-dimensional wavelet transform;

FIG. 4 is a diagram showing a coefficient matrix which is obtained by a wavelet transform in a vertical direction with respect to the tile image shown in FIG. 3;

FIG. 5 is a diagram showing a coefficient matrix which is obtained by a wavelet transform in a horizontal direction with respect to the coefficient matrix shown in FIG. 4;

FIG. 6 is a diagram showing a coefficient matrix which is obtained by deinterleaving the coefficient matrix shown in FIG. 5;

FIG. 7 is a diagram showing a coefficient matrix which is obtained by two two-dimensional wavelet transforms;

FIGS. 8A through 8D are diagrams for illustrating sub-band decomposition by the two-dimensional wavelet transform in 3 decomposition levels;

FIG. 9 is a diagram showing a relationship of tiles, sub-bands, precincts and code blocks;

FIG. 10 is a system block diagram showing an image processing system to which embodiments of the present invention may be applied;

FIGS. 11A through 11D are diagrams for illustrating an original image, an aspect ratio and image regions having different sizes;

FIGS. 12A and 12B are diagrams for illustrating divided regions in a compression process;

FIGS. 13A and 13B are diagrams for illustrating the divided regions in the compression process;

FIGS. 14A and 14B are diagrams for illustrating the divided regions in the compression process;

FIG. 15 is a system block diagram showing a structure of an image processing apparatus;

FIG. 16 is a flow chart for illustrating an operation of the image processing apparatus shown in FIG. 15;

FIG. 17 is a system block diagram showing a structure of an image processing apparatus;

FIG. 18 is a flow chart for illustrating an operation of the image processing apparatus shown in FIG. 17;

FIG. 19 is a system block diagram showing a structure of an image processing apparatus;

FIG. 20 is a flow chart for illustrating an operation of the image processing apparatus shown in FIG. 19;

FIG. 21 is a system block diagram showing a structure of an image processing apparatus;

FIG. 22 is a flow chart for illustrating an operation of the image processing apparatus shown in FIG. 21; and

FIG. 23 is a system block diagram showing an embodiment of an electronic camera according to one embodiment of the present invention.

### DESCRIPTION OF THE PREFERRED EMBODIMENTS

Accordingly, one or more embodiments of the present invention include a novel and useful image processing method, image processing apparatus, electronic camera and computer-readable storage medium, in which the problems described above are eliminated.

Other and more specific embodiments of the present invention comprise an image processing method, an image processing apparatus, an electronic camera and a computer-readable storage medium, which can achieve any one of the following embodiments (o1)-(o5).

(o1)To carry out an image compression process or, a conversion process with respect to encoded data of an image, in order to generate encoded data which enables reproduction of an image having an aspect ratio and/or size different from the aspect ratio and/or size of an original image by carrying out an expansion process only with respect to required codes.

(o2)To carry out an image compression process or, a conversion process with respect to encoded data of an image, in order to generate encoded data which is easily convertible to encoded data of an image having an aspect ratio and/or size different from the aspect ratio and/or size of an original image.

(o3)To convert encoded data of an image into encoded data consisting solely of codes necessary to reproduce an image having an aspect ratio and/or size different from the aspect ratio and/or size of an original image.

(o4)To generate, from encoded data of an image, encoded data consisting solely of codes necessary to reproduce an image having an aspect ratio and/or size of a screen of an external device or a window in the screen, and to output the generated encoded data to the external device.

(o5)To reproduce an image that is to be displayed on a screen or, a window of the screen, which has an aspect ratio and/or size different from the aspect ratio and/or size of an original image, by carrying out an expansion process only with respect to necessary codes of encoded data of the image.

Still another and more specific embodiment of the present invention includes an image processing method comprising carrying out a compression process that divides an image into a plurality of divided regions and compresses the divided regions in a state where each of the divided regions are independent of one another; and setting boundaries of the divided regions in order to approximately match boundaries of one or a plurality of image regions which are within the image and have aspect ratios and/or sizes different from those of the image. According to one embodiment of the image processing method of the present invention, the image of the image region can be reproduced by expanding only the codes of the generated encoded data corresponding to the image region having the aspect ratio and/or size different from those of the original image. In addition, by carrying out the conversion process with respect to the encoded data, it is possible to easily generate the encoded data consisting solely of the codes of the image region having the aspect ratio and/or size different from those of the original image. Hence, by setting in advance the aspect ratios and/or sizes of the screen or window which have a possibility of being used for the image display, it becomes unnecessary to prepare encoded data corresponding to various aspect ratios and/or sizes, and further, it is possible to reproduce the image for displaying the screen or window having the aspect ratio and/or size different from those of the original image without the need to carry out an additional process such as extracting, enlarging and reducing the image.

A further embodiment of the present invention includes an image processing method comprising carrying out a compression process with respect to an image by employing a compression algorithm in conformance with JPEG2000; and setting an image region that is within the image and has an aspect ratio and/or size different from those of the image, as a Region Of Interest (ROI). According to one embodiment of the image processing method of the present invention, the image of the image region can be reproduced by expanding only the codes of the generated encoded data corresponding to the image region having the aspect ratio and/or size different from those of the original image. In addition, by carrying out the conversion process with respect to the encoded data, it is possible to easily generate the encoded data consisting solely of the codes of the image region having the aspect ratio and/or size different from those of the original image. Hence, by setting in advance the aspect ratios and/or sizes of the screen or window which have a possibility of being used for the image display, it becomes unnecessary to prepare encoded data corresponding to various aspect ratios and/or sizes, and further, it is possible to reproduce the image for displaying the screen or window having the aspect ratio and/or size different from those of the original image without the need to carry out an additional process such as extracting, enlarging and reducing the image.

Another embodiment of the present invention includes an image processing method comprising obtaining encoded data which has been compressed by dividing an image into a plurality of divided regions and compressing the divided regions in a state where each of the divided regions are independent of one another; and converting the encoded data into converted encoded data so that boundaries of the divided regions of the encoded data approximately match boundaries of one or a plurality of image regions of the converted encoded data, wherein the image regions are within the image and have aspect ratios and/or sizes different from those of the image. According to one embodiment of the image processing method of the present invention, the image of the image region can be reproduced by expanding only the codes of the generated encoded data corresponding to the image region having the aspect ratio and/or size different from those of the original image. In addition, by carrying out the conversion process with respect to the encoded data, it is possible to easily generate the encoded data consisting solely of the codes of the image region having the aspect ratio and/or size different from those of the original image. Hence, by setting in advance the aspect ratios and/or sizes of the screen or window which have a possibility of being used for the image display, it becomes unnecessary to prepare encoded data corresponding to various aspect ratios and/or sizes, and further, it is possible to reproduce the image for displaying the screen or window having the aspect ratio and/or size different from those of the original image without the need to carry out an additional process such as extracting, enlarging and reducing the image.

Still another embodiment of the present invention includes an image processing method comprising carrying out a conversion process with respect to encoded data of an image that has been compressed by employing a compression algorithm in conformance with JPEG2000; and converting the encoded data into converted encoded data of an image region that is within the image and has an aspect ratio and/or size different from those of the image, as a Region Of Interest (ROI). According to one embodiment of the image processing method of the present invention, the image of the image region can be reproduced by expanding only the codes of the generated encoded data corresponding to the image region having the aspect ratio and/or size different from those of the original image. In addition, by carrying out the conversion process with respect to the encoded data, it is possible to easily generate the encoded data consisting solely of the codes of the image region having the aspect ratio and/or size different from those of the original image. Hence, by setting in advance the aspect ratios and/or sizes of the screen or window which have a possibility of being used for the image display, it becomes unnecessary to prepare encoded data corresponding to various aspect ratios and/or sizes, and further, it is possible to reproduce the image for displaying the screen or window having the aspect ratio and/or size different from those of the original image without the need to carry out an additional process such as extracting, enlarging and reducing the image.

A further embodiment of the present invention includes an image processing apparatus comprising a compression unit to carry out a compression process that divides an image into a plurality of divided regions and compresses the divided regions in a state where each of the divided regions are independent of one another; a first setting unit to set aspect ratios and/or sizes; and a second setting unit to set boundaries of the divided regions in order to approximately match boundaries of one or a plurality of image regions which are within the image and have aspect ratios and/or sizes set by the first setting unit. According to one embodiment of the image processing apparatus of the present invention, the image of the image region can be reproduced by expanding only the codes of the generated encoded data corresponding to the image region having the aspect ratio and/or size different from those of the original image. In addition, by carrying out the conversion process with respect to the encoded data, it is possible to easily generate the encoded data consisting solely of the codes of the image region having the aspect ratio and/or size different from those of the original image. Hence, by setting in advance the aspect ratios and/or sizes of the screen or window which have a possibility of being used for the image display, it becomes unnecessary to prepare encoded data corresponding to various aspect ratios and/or sizes, and further, it is possible to reproduce the image for displaying the screen or window having the aspect ratio and/or size different from those of the original image without the need to carry out an additional process such as extracting, enlarging and reducing the image.

Another embodiment of the present invention includes an image processing apparatus comprising a compression unit to carry out a compression process with respect to an image by employing a compression algorithm in conformance with JPEG2000; a first setting unit to set an aspect ratio and/or size; and a second setting unit to set an image region that is within the image and has the aspect ratio and/or size set by the first setting unit, as a Region Of Interest (ROI). According to one embodiment of the image processing apparatus of the present invention, the image of the image region can be reproduced by expanding only the codes of the generated encoded data corresponding to the image region having the aspect ratio and/or size different from those of the original image. In addition, by carrying out the conversion process with respect to the encoded data, it is possible to easily generate the encoded data consisting solely of the codes of the image region having the aspect ratio and/or size different from those of the original image. Hence, by setting in advance the aspect ratios and/or sizes of the screen or window which have a possibility of being used for the image display, it becomes unnecessary to prepare encoded data corresponding to various aspect ratios and/or sizes, and further, it is possible to reproduce the image for displaying the screen or window having the aspect ratio and/or size different from those of the original image without the need to carry out an additional process such as extracting, enlarging and reducing the image.

Still another embodiment of the present invention includes a image processing apparatus comprising an obtaining unit to obtain encoded data which has been compressed by dividing an image into a plurality of divided regions and compressing the divided regions in a state where each of the divided regions are independent of one another; a first setting unit to set aspect ratios and/or sizes; a second setting unit to set the divided regions so that boundaries of the divided regions approximately match boundaries of one or a plurality of image regions which are within the image and have the aspect ratios and/or sizes set by the first setting unit; and a conversion unit to convert the encoded data into converted encoded data which has been compressed using the divided regions set by the second setting unit. According to one embodiment of the image processing apparatus of the present invention, the image of the image region can be reproduced by expanding only the codes of the generated encoded data corresponding to the image region having the aspect ratio and/or size different from those of the original image. In addition, by carrying out the conversion process with respect to the encoded data, it is possible to easily generate the encoded data consisting solely of the codes of the image region having the aspect ratio and/or size different from those of the original image. Hence, by setting in advance the aspect ratios and/or sizes of the screen or window which have a possibility of being used for the image display, it becomes unnecessary to prepare encoded data corresponding to various aspect ratios and/or sizes, and further, it is possible to reproduce the image for displaying the screen or window having the aspect ratio and/or size different from those of the original image without the need to carry out an additional process such as extracting, enlarging and reducing the image.

A further embodiment of the present invention includes an image processing apparatus comprising a conversion unit to carry out a conversion process with respect to encoded data of an image that has been compressed by employing a compression algorithm in conformance with JPEG2000; a first setting unit to set an aspect ratio and/or size; and a second setting unit to set an image region that is within the image and has the aspect ratio and/or size set by the first setting unit, as a Region Of Interest (ROI), where the conversion unit converts the encoded data into converted encoded data having the Region Of Interest (ROI). According to one embodiment of the image processing apparatus of the present invention, the image of the image region can be reproduced by expanding only the codes of the generated encoded data corresponding to the image region having the aspect ratio and/or size different from those of the original image. In addition, by carrying out the conversion process with respect to the encoded data, it is possible to easily generate the encoded data consisting solely of the codes of the image region having the aspect ratio and/or size different from those of the original image. Hence, by setting in advance the aspect ratios and/or sizes of the screen or window which have a possibility of being used for the image display, it becomes unnecessary to prepare encoded data corresponding to various aspect ratios and/or sizes, and further, it is possible to reproduce the image for displaying the screen or window having the aspect ratio and/or size different from those of the original image without the need to carry out an additional process such as extracting, enlarging and reducing the image.

The image processing apparatus may comprise a conversion unit to convert encoded data of the image into encoded data consisting solely of codes corresponding to the image regions. In this case, it is possible to generate, from the encoded data of the image, the converted encoded data consisting solely of the codes necessary to reproduce the image having the aspect ratio and/or size different from those of the original image. Thus, by supplying the converted encoded data to a display unit or the like which displays the image in the screen or window having the aspect ratio and/or size different from those of the original image, it becomes possible to efficiently display the image without requiring an additional process such as extracting, enlarging and reducing the image.

The image processing apparatus may comprise a communication unit to communicate with an external device, where the first setting unit sets the aspect ratios and/or sizes according to information which specifies the aspect ratios and/or sizes and is received from the external device by the communication unit, and a conversion unit to convert encoded data of the image into converted encoded data consisting solely of codes corresponding to the image regions, where the communication unit transmits the converted encoded data to the external device. In this case, it is possible to transmit to a transmission request source the encoded data consisting solely of the codes necessary to reproduce the image having the aspect ratio and/or size of the screen or window of the transmission request source. For this reason, the transmission request source can efficiently display the image without requiring an additional process. Moreover, it is possible to reduce the reception time of the encoded data at the transmission request source because the transmission request source does not receive unnecessary codes. Furthermore, at the image processing apparatus, it is also possible to reduce the transmission time of the encoded data because unnecessary codes are not transmitted. In addition, the cost for storing the encoded data at the image processing apparatus can be reduced since it is unnecessary to store various encoded data corresponding different aspect ratios and/or sizes.

The image processing apparatus may comprise an expansion unit to expand encoded data of the image by expanding only codes corresponding to the image regions. In this case, it is possible to efficiently reproduce the image that is to be displayed in the screen or window having the aspect ratio and/or size different from those of the original image, without requiring an additional process such as expansion of unnecessary codes, and extraction, enlargement and reduction of the image.

Another embodiment of the present invention includes an electronic camera for picking up a still or dynamic image, comprising an imaging unit to pick up an image; a compression unit to carry out a compression process which divides the image into a plurality of divided regions and compresses the divided regions in a state where each of the divided regions are independent of one another; a first setting unit to set aspect ratios and/or sizes; and a second setting unit to set boundaries of the divided regions in order to approximately match boundaries of one or a plurality of image regions which are within the image and have aspect ratios and/or sizes set by the first setting unit. According to one embodiment of the electronic camera of the present invention, the image of the image region can be reproduced by expanding only the codes of the generated encoded data corresponding to the image region having the aspect ratio and/or size different from those of the original image. In addition, by carrying out the conversion process with respect to the encoded data, it is possible to easily generate the encoded data consisting solely of the codes of the image region having the aspect ratio and/or size different from those of the original image. Hence, by setting in advance the aspect ratios and/or sizes of the screen or window which have a possibility of being used for the image display, it becomes unnecessary to prepare encoded data corresponding to various aspect ratios and/or sizes, and further, it is possible to reproduce the image for displaying the screen or window having the aspect ratio and/or size different from those of the original image without the need to carry out an additional process such as extracting, enlarging and reducing the image.

Still another embodiment of the present invention includes an electronic camera for picking up a still or dynamic image, comprising an imaging unit to pick up an image; a compression unit to carry out a compression process with respect to the image by employing a compression algorithm in conformance with JPEG2000; a first setting unit to set an aspect ratio and/or size; and a second setting unit to set an image region that is within the image and has the aspect ratio and/or size set by the first setting unit, as a Region Of Interest (ROI). According to one embodiment of the electronic camera of the present invention, the image of the image region can be reproduced by expanding only the codes of the generated encoded data corresponding to the image region having the aspect ratio and/or size different from those of the original image. In addition, by carrying out the conversion process with respect to the encoded data, it is possible to easily generate the encoded data consisting solely of the codes of the image region having the aspect ratio and/or size different from those of the original image. Hence, by setting in advance the aspect ratios and/or sizes of the screen or window which have a possibility of being used for the image display, it becomes unnecessary to prepare encoded data corresponding to various aspect ratios and/or sizes, and further, it is possible to reproduce the image for displaying the screen or window having the aspect ratio and/or size different from those of the original image without the need to carry out an additional process such as extracting, enlarging and reducing the image.

A further embodiment of the present invention includes an electronic camera for picking up a still or dynamic image, comprising an imaging unit to pick up an image; an obtaining unit to obtain encoded data which has been compressed by dividing the image into a plurality of divided regions and compressing the divided regions in a state where each of the divided regions are independent of one another; a first setting unit to set aspect ratios and/or sizes; a second setting unit to set the divided regions so that boundaries of the divided regions approximately match boundaries of one or a plurality of image regions which are within the image and have the aspect ratios and/or sizes set by the first setting unit; and a conversion unit to convert the encoded data into converted encoded data which has been compressed using the divided regions set by the second setting unit. According to one embodiment of the electronic camera of the present invention, the image of the image region can be reproduced by expanding only the codes of the generated encoded data corresponding to the image region having the aspect ratio and/or size different from those of the original image. In addition, by carrying out the conversion process with respect to the encoded data, it is possible to easily generate the encoded data consisting solely of the codes of the image region having the aspect ratio and/or size different from those of the original image. Hence, by setting in advance the aspect ratios and/or sizes of the screen or window which have a possibility of being used for the image display, it becomes unnecessary to prepare encoded data corresponding to various aspect ratios and/or sizes, and further, it is possible to reproduce the image for displaying the screen or window having the aspect ratio and/or size different from those of the original image without the need to carry out an additional process such as extracting, enlarging and reducing the image.

Another embodiment of the present invention includes an electronic camera for picking up a still or dynamic image, comprising an imaging unit to pick up an image; a conversion unit to carry out a conversion process with respect to encoded data of the image that has been compressed by employing a compression algorithm in conformance with JPEG2000; a first setting unit to set an aspect ratio and/or size; and a second setting unit to set an image region that is within the image and has the aspect ratio and/or size set by the first setting unit, as a Region Of Interest (ROI), where the conversion unit converts the encoded data into converted encoded data having the Region Of Interest (ROI). According to one embodiment of the electronic camera of the present invention, the image of the image region can be reproduced by expanding only the codes of the generated encoded data corresponding to the image region having the aspect ratio and/or size different from those of the original image. In addition, by carrying out the conversion process with respect to the encoded data, it is possible to easily generate the encoded data consisting solely of the codes of the image region having the aspect ratio and/or size different from those of the original image. Hence, by setting in advance the aspect ratios and/or sizes of the screen or window which have a possibility of being used for the image display, it becomes unnecessary to prepare encoded data corresponding to various aspect ratios and/or sizes, and further, it is possible to reproduce the image for displaying the screen or window having the aspect ratio and/or size different from those of the original image without the need to carry out an additional process such as extracting, enlarging and reducing the image.

Still another embodiment of the present invention includes a computer-readable storage medium which stores a program for causing a computer to carry out an image processing, the program comprising a compression procedure causing the computer to carry out a compression process which divides an image into a plurality of divided regions and compresses the divided regions in a state where each of the divided regions are independent of one another; and a setting procedure causing the computer to set boundaries of the divided regions in order to approximately match boundaries of one or a plurality of image regions which are within the image and have aspect ratios and/or sizes different from those of the image. According to one embodiment of the computer-readable storage medium of the present invention, the image of the image region can be reproduced by expanding only the codes of the generated encoded data corresponding to the image region having the aspect ratio and/or size different from those of the original image. In addition, by carrying out the conversion process with respect to the encoded data, it is possible to easily generate the encoded data consisting solely of the codes of the image region having the aspect ratio and/or size different from those of the original image. Hence, by setting in advance the aspect ratios and/or sizes of the screen or window which have a possibility of being used for the image display, it becomes unnecessary to prepare encoded data corresponding to various aspect ratios and/or sizes, and further, it is possible to reproduce the image for displaying the screen or window having the aspect ratio and/or size different from those of the original image without the need to carry out an additional process such as extracting, enlarging and reducing the image.

A further embodiment of the present invention includes a computer-readable storage medium which stores a program for causing a computer to carry out an image processing, the program comprising a procedure causing the computer to carry out a compression process with respect to an image by employing a compression algorithm in conformance with JPEG2000; and a procedure causing the computer to set an image region that is within the image and has an aspect ratio and/or size different from those of the image, as a Region Of Interest (ROI). According to one embodiment of the computer-readable storage medium of the present invention, the image of the image region can be reproduced by expanding only the codes of the generated encoded data corresponding to the image region having the aspect ratio and/or size different from those of the original image. In addition, by carrying out the conversion process with respect to the encoded data, it is possible to easily generate the encoded data consisting solely of the codes of the image region having the aspect ratio and/or size different from those of the original image. Hence, by setting in advance the aspect ratios and/or sizes of the screen or window which have a possibility of being used for the image display, it becomes unnecessary to prepare encoded data corresponding to various aspect ratios and/or sizes, and further, it is possible to reproduce the image for displaying the screen or window having the aspect ratio and/or size different from those of the original image without the need to carry out an additional process such as extracting, enlarging and reducing the image.

Another embodiment of the present invention includes a computer-readable storage medium which stores a program for causing a computer to carry out an image processing, the program comprising an obtaining procedure causing the computer to obtain encoded data which has been compressed by dividing an image into a plurality of divided regions and compressing the divided regions in a state where each of the divided regions are independent of one another; and a conversion procedure causing the computer to convert the encoded data into converted encoded data so that boundaries of the divided regions of the encoded data approximately match boundaries of one or a plurality of image regions of the converted encoded data, wherein the image regions are within the image and have aspect ratios and/or sizes different from those of the image. According to one embodiment of the computer-readable storage medium of the present invention, the image of the image region can be reproduced by expanding only the codes of the generated encoded data corresponding to the image region having the aspect ratio and/or size different from those of the original image. In addition, by carrying out the conversion process with respect to the encoded data, it is possible to easily generate the encoded data consisting solely of the codes of the image region having the aspect ratio and/or size different from those of the original image. Hence, by setting in advance the aspect ratios and/or sizes of the screen or window which have a possibility of being used for the image display, it becomes unnecessary to prepare encoded data corresponding to various aspect ratios and/or sizes, and further, it is possible to reproduce the image for displaying the screen or window having the aspect ratio and/or size different from those of the original image without the need to carry out an additional process such as extracting, enlarging and reducing the image.

Still another embodiment of the present invention includes a computer-readable storage medium which stores a program for causing a computer to carry out an image processing, the program comprising a procedure causing the computer to carry out a conversion process with respect to encoded data of an image that has been compressed by employing a compression algorithm in conformance with JPEG2000; and a procedure causing the computer to convert the encoded data into converted encoded data of an image region that is within the image and has an aspect ratio and/or size different from those of the image, as a Region Of Interest (ROI). According to one embodiment of the computer-readable storage medium of the present invention, the image of the image region can be reproduced by expanding only the codes of the generated encoded data corresponding to the image region having the aspect ratio and/or size different from those of the original image. In addition, by carrying out the conversion process with respect to the encoded data, it is possible to easily generate the encoded data consisting solely of the codes of the image region having the aspect ratio and/or size different from those of the original image. Hence, by setting in advance the aspect ratios and/or sizes of the screen or window which have a possibility of being used for the image display, it becomes unnecessary to prepare encoded data corresponding to various aspect ratios and/or sizes, and further, it is possible to reproduce the image for displaying the screen or window having the aspect ratio and/or size different from those of the original image without the need to carry out an additional process such as extracting, enlarging and reducing the image.

Other embodiments and further features of the present invention will be apparent from the following detailed description when read in conjunction with the accompanying drawings. According to the compression algorithm of the JPEG2000, the image is divided into a plurality of regions, and each of the divided regions are compressed in a state where the divided regions are not dependent upon one another (that is, independent of one another). In embodiments of the present invention described hereunder, the embodiments (o1)-(o5) described above are achieved by positively utilizing the features of the compression algorithm of the JPEG2000. In addition, the JPEG2000 includes a Region Of Interest (ROI) function for making a specific region have a high picture quality, by performing a bit-shift of wavelet coefficients. The embodiments of the present invention also utilize the ROI function to achieve the embodiments (o1)-(o5) described above.

Next, a description will be given of embodiments of an image processing method according to one embodiment of the present invention; an image processing apparatus, according to one embodiment of the present invention; an electronic camera, according to one embodiment of the present invention; and a computer-readable storage medium, according to one embodiment of the present invention, under a precondition that these embodiments utilize the compression algorithm of the JPEG2000. In order to facilitate the understanding of the subject matter of the present invention, a brief description will be given of the operating principle of the JPEG2000.

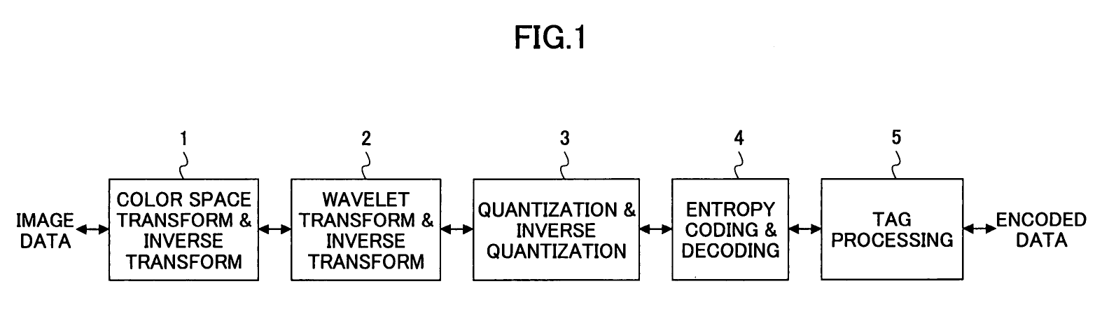

FIG. 1 is a system block diagram for illustrating basic compression and expansion algorithms of the JPEG2000. A system shown in FIG. 1 includes a color space transform and inverse transform unit 1, a two-dimensional wavelet transform an inverse transform unit 2, a quantization and inverse quantization unit 3, an entropy encoding and decoding unit 4, and a tag processing unit 5. Image data to be subjected to the compression process is divided non-overlapping rectangular regions (hereinafter referred to as tiles) for every component, and processed in units of tiles for every component. However, it is of course possible to process the entire image as a single tile.

Each tile image of each component is subjected to a color space transform in the color space transform and inverse transform unit 1 for the purpose of improving the compression ratio, and is transformed from RGB or CMY data into YCrCb data. This color space transform may be omitted in some cases.

The tile image after the color space transform is subjected to a two-dimensional wavelet transform in the wavelet transform and inverse transform unit 2, and is decomposed into a plurality of sub-bands. Wavelet coefficients are quantized for every band in the quantization and inverse quantization unit 3. The JPEG2000 can carry out a reversible compression (lossless compression) and an irreversible compression (lossy compression). In one embodiment in the case of the reversible compression, the quantization step size is always “1,” and substantially no quantization takes place at this stage.

Each sub-band coefficient after the quantization is subjected to an entropy encoding in the entropy encoding and decoding unit 4. A block-based bit-plane encoding scheme called Embedded Block Coding with Optimized Truncation (EBCOT) that uses block division, coefficient modeling and binary arithmetic coding, is used for the entropy encoding. The bit-plane of each sub-band coefficient after the quantization is encoded for every block called a code block, from upper bits towards lower bits.

The tag processing unit 5 creates packets by combining the codes of the code blocks generated by the entropy encoding and decoding unit 4, and then the packets are arranged according to a progressive sequence and added with necessary tag information, to thereby create encoded data of a predetermined format. In the JPEG2000, five kinds of progression sequences are defined with respect to the code sequence control, by combinations of the resolution level, the position (precinct), the layer, and the component (color component).

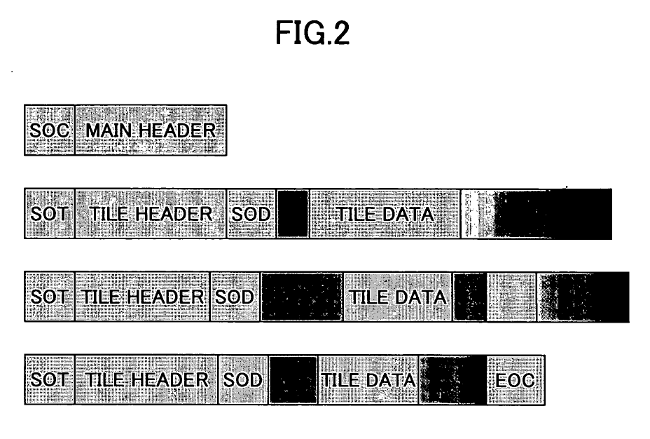

FIG. 2 is a diagram showing a format of the encoded data generated according to the JPEG2000. As shown in FIG. 2, the encoded data starts with a tag called a SOC marker that indicates the start of the encoded data. Tag information called Main Header follows the SOC marker. Encoding parameters, quantization parameters and the like are written in the Main Header. Encoded data of each tile follows the Main Header. The encoded data of each file starts with a tag called an SOT marker, and includes tag information called Tile Header, a tag called SOD marker, and Tile Data having the code sequence of each tile as its contents. A tag called an EOC marker, which indicates the end of the encoded data, follows the last Tile Data.

The expansion process carries out the processes in reverse order to those of the compression process. The encoded data is decomposed into the code sequence of each tile of each component in the tag processing unit 5. The code sequence is subjected to an entropy decoding in the entropy encoding and decoding unit 4. The decoded wavelet coefficients are subjected to an inverse quantization in the quantization and inverse quantization unit 3, and then subjected to a two-dimensional inverse wavelet transform in the wavelet transform and inverse transform unit 2, in order to reproduce the image of each tile of each component. Each tile image of each component is subjected to an inverse color space transform in the color space transform and inverse transform unit 1, and returned to the tile image that is formed by the components such as the RGB components.

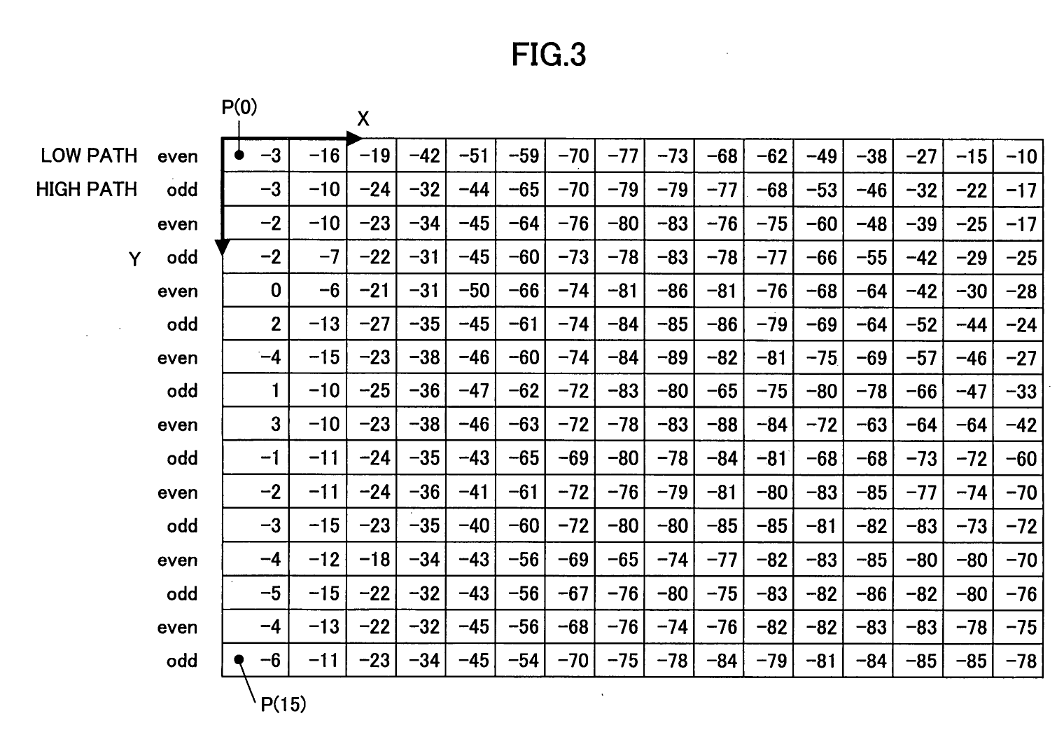

Next, a description will be given of the two-dimensional wavelet transform. FIGS. 3 through 7 are diagrams for illustrating the wavelet transform, which is called the “5×3 transform” and employed in the JPEG2000, and carried out in the vertical direction and the horizontal direction, with respect to a 16×16 pixel tile image of a monochrome image (or one component of a color image).

FIG. 3 is a diagram showing a tile image before the two-dimensional wavelet transform. The XY coordinates are defined as shown in FIG. 3, and a pixel value of a pixel having a Y-coordinate y for a certain X-coordinate x is denoted by P(y), where 0≦y≦15 in this particular case. According to the JPEG2000, a coefficient C(2i+1) is obtained by first performing highpass filtering in the vertical direction (Y-direction) about a center pixel having an odd Y-coordinate (y=2i+1), where i=0, 1, 2, . . . . Then, a coefficient C(2i) is obtained by performing lowpass filtering in the vertical direction (Y-direction) about a center pixel having an even Y-coordinate (y=2i). Such operations are performed with respect to all x. The highpass filtering can be described by the following formula (1), and the lowpass filtering can be described by the following formula (2), where floor(x) denotes a floor function of x. The floor function floor(x) converts a real number x to an integer that is closest to x but not exceeding x.

C(21i+1)=P(2i+1)−floor((P(2i)+P(2i+2)/2) (1)

C(2i)=P(2i)+floor((C(2i−1)+C(2i+1)+2)/4) (2)

At an edge portion of the image, a group of adjacent pixels may not exist with respect to the center pixel. In such a case, the so-called mirroring technique is used to compensate for the lacking pixel values. The mirroring technique turns the pixel values symmetrically about a boundary by regarding the boundary as the center, and regards the turned pixel values as the pixel values of the group of adjacent pixels.

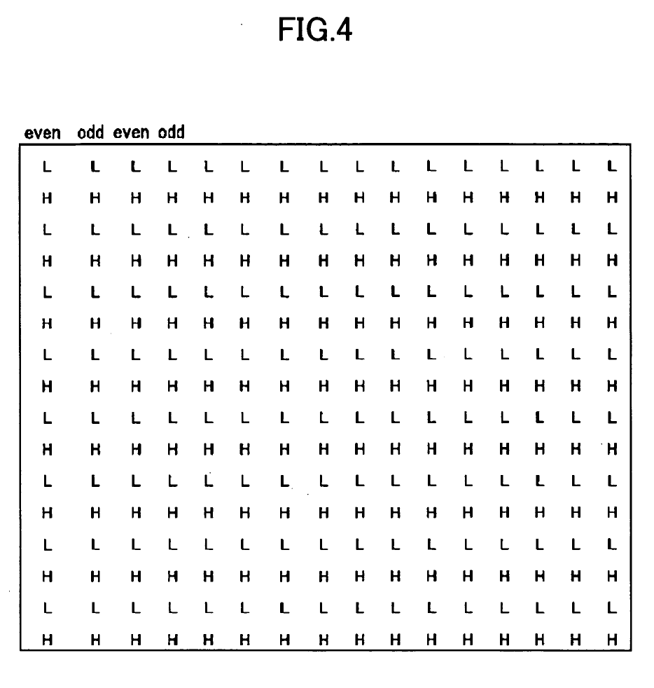

If the coefficients obtained by the highpass filtering are denoted by H, and the coefficients obtained by the lowpass filtering are denoted by L, the image shown in FIG. 3 is transformed into a matrix of coefficients L and coefficients H by a transform in a vertical direction, as shown in FIG. 4. FIG. 4 is a diagram showing the coefficient matrix that is obtained by the wavelet transform in the vertical direction with respect to the tile image shown in FIG. 3.

Next, with respect to the coefficient matrix shown in FIG. 4, a highpass filtering is performed in the horizontal direction (X-direction) about a center coefficient having an odd X-coordinate (x=2i+1). Then, a lowpass filtering is performed in the horizontal direction (X-direction) about a center coefficient having an even X-coordinate (x=2i). Such operations are performed with respect to all y. In this case, P(2i) and the like of the formulas described above are read as describing the coefficient values.

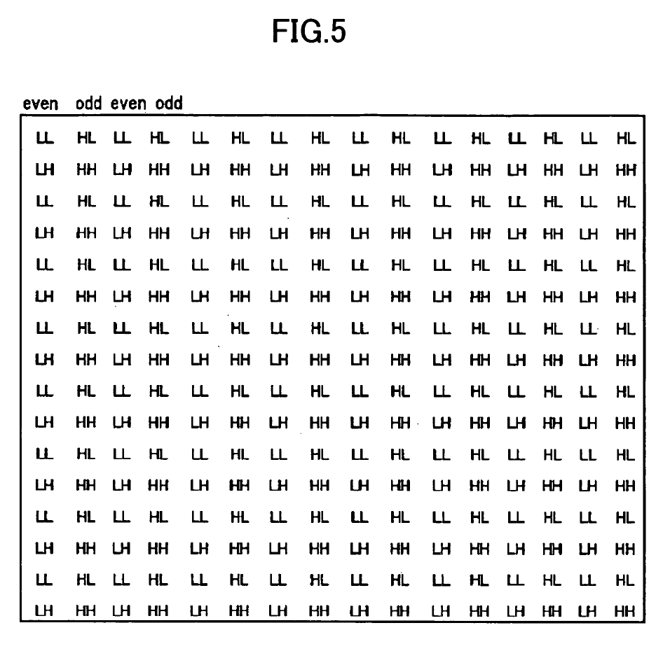

If a coefficient obtained by performing a lowpass filtering about a center coefficient L is denoted by LL, a coefficient obtained by performing a highpass filtering about a center coefficient L is denoted by HL, a coefficient obtained by performing a lowpass filtering about a center coefficient H is denoted by LH, and a coefficient obtained by performing a highpass filtering about a center coefficient H is denoted by HH, the coefficient matrix shown in FIG. 4 is transformed into a coefficient matrix shown in FIG. 5. FIG. 5 is a diagram showing the coefficient matrix that is obtained by the wavelet transform in the horizontal direction with respect to the coefficient matrix shown in FIG. 4. In FIG. 5, a group of coefficients denoted by the same reference character is called the sub-band, and the coefficient matrix shown in FIG. 5 is formed by 4 sub-bands.

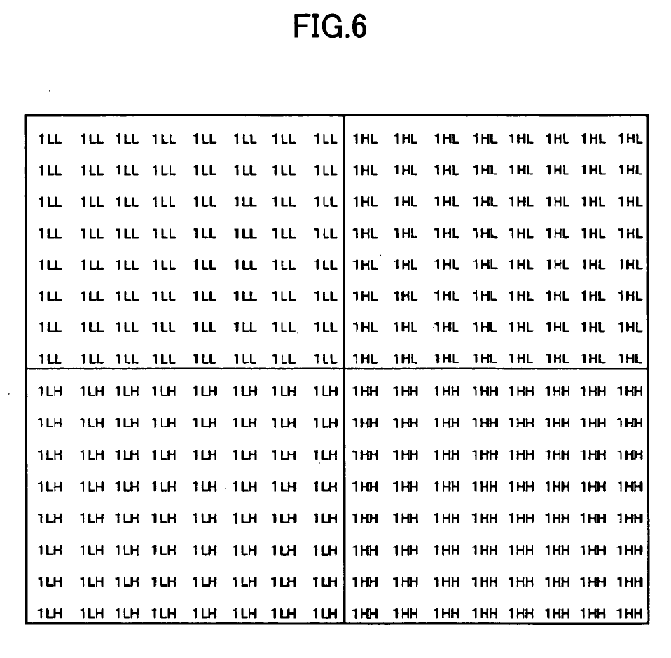

One wavelet transform (one decomposition) ends by the operations described above. FIG. 6 is a diagram showing a coefficient matrix that is obtained by deinterleaving the coefficient matrix shown in FIG. 5. In other words, the coefficients are arranged as shown in FIG. 5 by interleaving, and the coefficients are collected for each sub band as shown in FIG. 6 by deinterleaving.

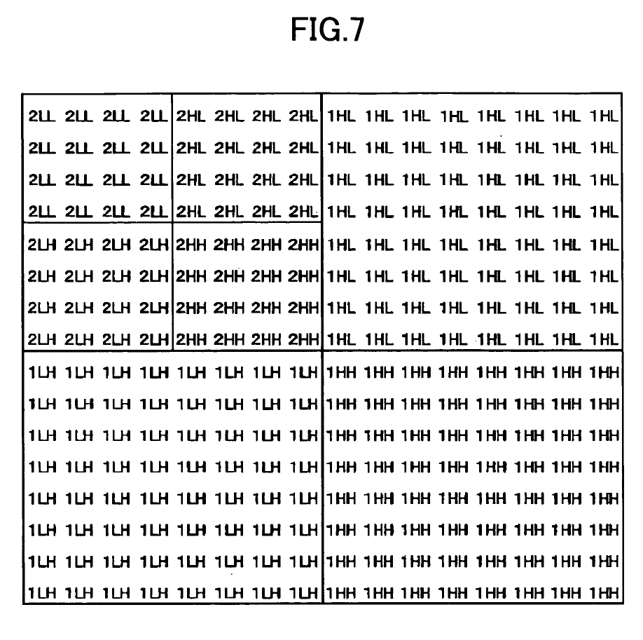

The second wavelet transform regards the LL sub-band as the original image, and the operations described above are similarly performed with respect to the LL sub-band. By deinterleaving the operation result, coefficients of the sub-bands are obtained as shown in FIG. 7. FIG. 7 is a diagram showing the coefficient matrix that is obtained by two two-dimensional wavelet transforms. In FIGS. 6 and 7, prefixes “1” and “2” of attached to the coefficients indicate the number of wavelet transforms performed to obtain each coefficient, that is, the decomposition level.

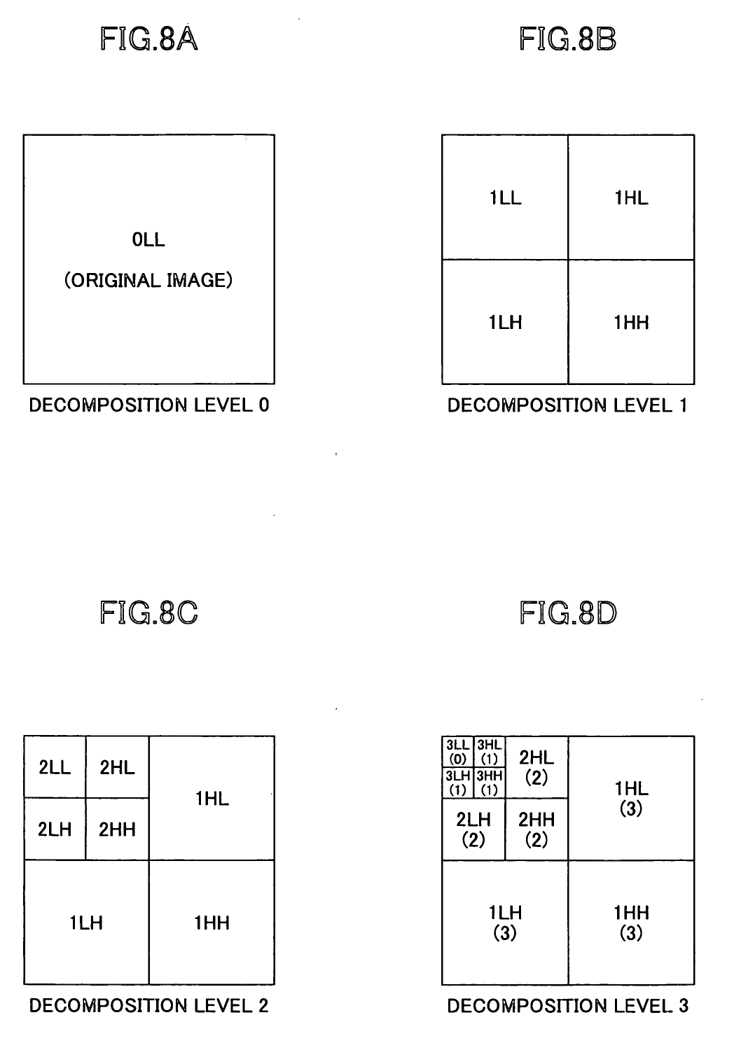

FIGS. 8A through 8D are diagrams for illustrating sub-band decomposition by the two-dimensional wavelet transform in 3 decomposition levels. FIG. 8A shows the sub-band of the decomposition level 0, that is, the original image. FIG. 8B shows the sub-bands of the decomposition level 1, FIG. 8C shows the sub-bands of the decomposition level 2, and FIG. 8D shows the sub-bands of the decomposition level 3. In FIG. 8D, numerals in parenthesis within each sub-band indicate the resolution level.

As described heretofore, according to the compression algorithm of the JPEG2000, the image is divided into a plurality of regions, and each of the divided regions is compressed in a state where the divided regions are not dependent upon one another (that is, independent of one another). The divided regions may be the tile or code block described above or, the precinct. These divided regions have sizes that satisfy a relationship (original image)≧(tile)≧(sub-band)≧(precinct)≧(code block). As may be readily understood from the description given above, the region in each deinterleaved sub-band has a 1:1 corresponding relationship to a specific region in the original image. Hence, both the precinct and the code block have a 1:1 corresponding relationship to a specific region in the original image.

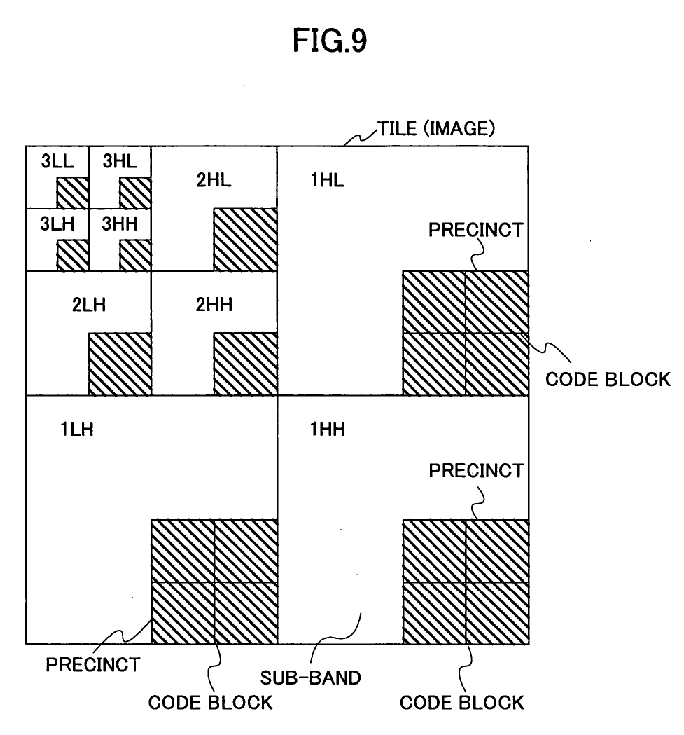

FIG. 9 is a diagram showing a relationship of the tiles, the sub-bands, the precincts and the code blocks for the decomposition level 3. In FIG. 9, a region that is within each sub-band and indicated by the halftone dot meshing is the precinct corresponding to the same region in the original image. As shown for the 3HL, 3LH and 3HH sub-bands, the precinct is divided into one or more code blocks.

A packet is obtained by extracting a portion of the code of the code block and collecting the extracted portion for all of the code blocks included in the precinct. For example, the code of 3 bit-planes, from the most significant bit (MSB) to the third most significant bit, of the code block is extracted. The packet may include a vacant portion that has no code. The encoded data is formed by generating the packets from the codes of the code blocks, and arranging the packets according to a desired progression sequence. In FIG. 2, the SOD and the following portion related to each file correspond to a collection of packets.

A layer is formed by a portion of the codes of the entire image region, which is obtained by collecting the packets of all of the precincts (that is, all of the code blocks and all of the sub-bands). For example, the portion of the codes of the entire image region forming the layer corresponds to the codes of the bit-planes from the most significant bit-plane to the third significant bit-plane of the wavelet coefficients of the entire image region. Accordingly, the picture quality of the reproduced image improves more as the number of layers decoded at the time of the expansion process increases. In other words, the number of layers may be regarded as a unit that indicates the picture quality. When all of the layers are collected, the codes of all of the bit-planes of the entire image region are obtained.

As described heretofore, each packet forming the encoded data according to the JEPG2000 includes indexes of the region, picture quality, the component and the resolution. Hence, it is possible to make an eclectic selection of the code in the encoded state, based the parameters such as the region, the picture quality, the component and the resolution. In other words, an arbitrary encoded data may be converted into another encoded data having modified parameters such as the region, picture quality, the component and the resolution, without having to expand the arbitrary encoded data.

In addition, the JPEG2000 has the Region Of Interest (ROI) function to selectively improve the picture quality of the regions, by reducing the compression ratio of a specific region (to improve the picture quality of the specific region) without having to reduce the compression ratio of the entire image. A function called the Max Shift, which performs a bit-shift with respect to the wavelet coefficients in the ROI, is prescribed under the ROI function. The encoded data may also be converted into an encoded data that uses the ROI as the above-described specific region of the image.

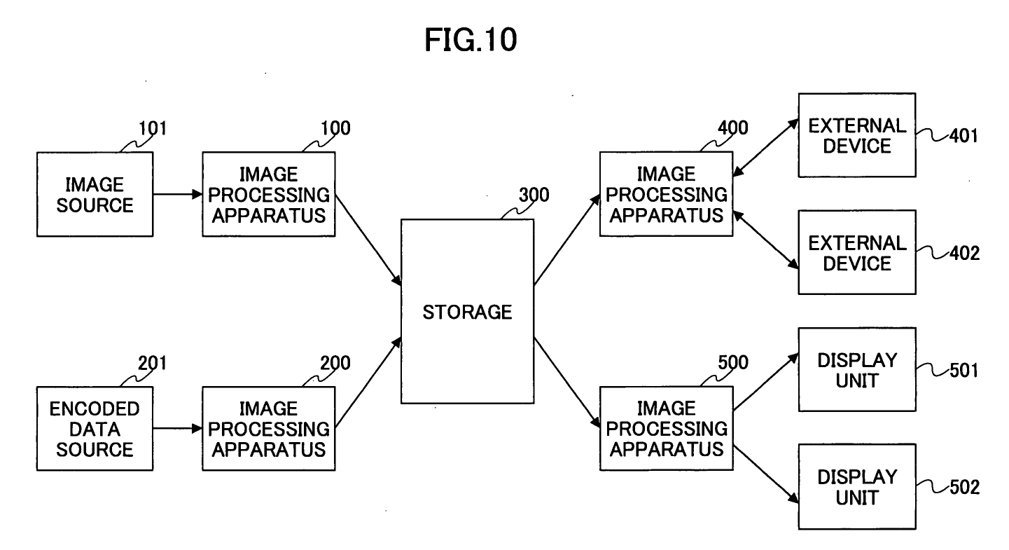

FIG. 10 is a system block diagram showing an image processing system to which embodiments of the present invention may be applied. The image processing system shown in FIG. 10 includes image processing apparatuses 100, 200, 400 and 500, an image source 101, encoded data source 201, a storage 300, external devices 401 and 402, and display units 501 and 502.

The image processing apparatus 100 inputs image data from the image source 101 and compresses the image data to output encoded data. The image processing apparatus 200 inputs encoded data of an image from the encoded data source 201, and carries out a conversion to output converted encoded data. The storage 300 stores the encoded data of the image output from the image processing apparatuses 100 and 200. The image processing apparatus 400 transmits the encoded data of the image stored in the storage 300 or, encoded data obtained by converting the encoded data stored in the storage 300, to the external devices 401 and 402 via a cable or wireless transmission path or network. The image processing apparatus 500 expands the encoded data of the image stored in the storage 300, and displays an image on the display units 501 and 502.

The image in this case may be a still image or, each frame of a dynamic image. In addition, the encoded data has a format in conformance with the JPEG2000.

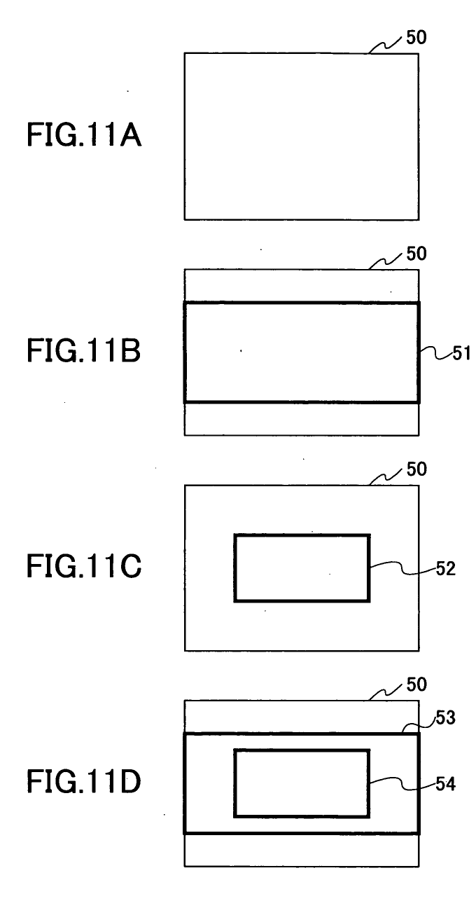

Next, a description will be given of an image processing of the image processing system shown in FIG. 10, by referring to FIGS. 11A through 14B.

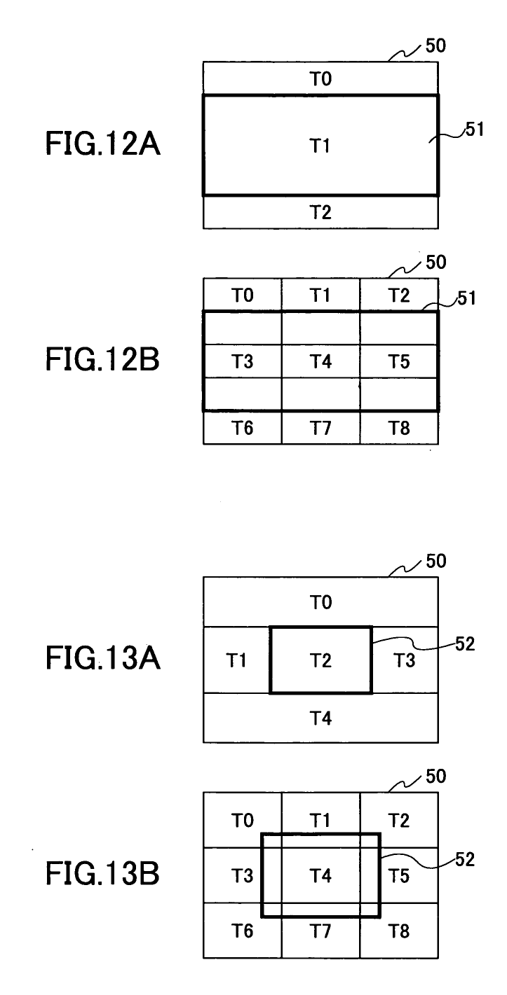

FIGS. 11A through 11D are diagrams for illustrating an original image, an aspect ratio and image regions having different sizes, and FIGS. 12A through 13B are diagrams for illustrating divided regions in the compression process.

FIG. 11A shows an image 50 that is input from the image source 101. This image has a certain size and a certain aspect ratio that is 4:3, for example. The image processing apparatus 100 compresses the image 50 to generate the encoded data. By setting a size and an aspect ratio different from those of the original image 50, the image processing apparatus 100 can generate the encoded data suited for displaying a screen or, a window in the screen, with the size and aspect ratio that are different from those of the original image 50. The different aspect ratio may be 16:9, for example.

In other words, the image processing apparatus 100 may generate image regions such as an image region 51 shown in FIG. 11B, an image region 52 shown in FIG. 11C and image regions 53 and 54 shown in FIG. 11D, which have the set size and aspect ratio. In addition, the divided regions in the compression process are set so that boundaries of the divided regions match boundaries of the image regions. In this case, the matching of the boundaries does not need to be a perfect match in pixel units, and may be an approximate match that does not greatly affect (or deteriorate) the reproduction and display of the image.

When the image region 51 shown in FIG. 11B is set, for example, tiles T0, T1 and T2 are set as shown in FIG. 12A, in order to match the boundaries of the tiles T0, T1 and T3 and the boundaries of the image region 51. Since the tile size can be described by an exponential of 2, if it is necessary for matching the boundaries, the tiles may be divided into smaller tiles in order to make the tile size uniform, for example. In addition, the boundaries of even smaller divided regions may be matched to the boundaries of the image region 51. For example, the tiles may be divided as shown in FIG. 12B, and the boundaries or the precincts or code blocks (not shown) may be matched to the boundaries of the image region 51.

When the image region 52 shown in FIG. 11C is set, for example, tiles T0 through T4 are set as shown in FIG. 13A, in order to match the boundaries of the tiles T0 through T4 and the boundaries of the image region 51. It is also possible to set tiles T0 through T8 as shown in FIG. 13B when the image region 52 shown in FIG. 11C is set, in order to match the boundaries of the precincts or code blocks and the boundaries of the image region 51.

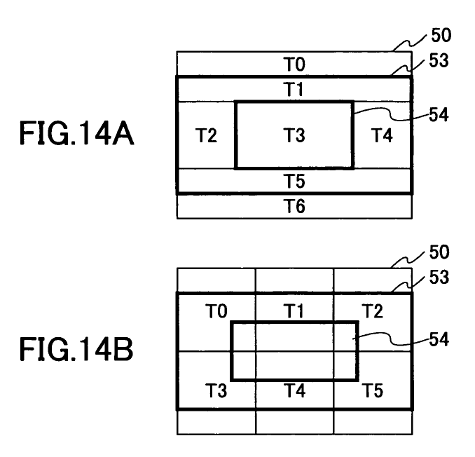

When the two image regions 53 and 54 shown in FIG. 11D are set, for example, tiles T0 through T6 are set as shown in FIG. 14A, in order to match the boundaries of the tiles T0 through T6 and the boundaries of the image regions 53 and 54. It is also possible to set tiles T0 through T5 as shown in FIG. 14B when the image regions 53 and 54 shown in FIG. 11D are set, in order to match the boundaries of the precincts or the code blocks and the boundaries of the image regions 53 and 54.

The encoded data according to the JPEG2000, which is obtained carrying out the compression by matching the boundaries of the tiles, precincts or code blocks and the boundaries of the image region, may be subjected to an expansion process which expands only the codes of the image region, and the image of the image region can be reproduced without requiring other special processes or operations. Furthermore, by extracting only the codes of the image region from the encoded data and recomposing the codes, it is possible to easily convert the encoded data to encoded data consisting solely of the codes of the image region.

The image processing apparatus 100 may set the image region as the ROI of the compression process. For example, the image region shown in FIG. 11B or, the image region 52 shown in FIG. 11C may be set as the ROI. In this case, the divided regions such as the tiles may be set as described above or, set without taking the boundaries of the image region into consideration. In addition, with respect to the image regions 53 and 54 shown in FIG. 11D, it is possible to match the boundaries of the tiles, precincts or code blocks and the boundaries of one of the image regions 53 and 54 (for example, the image region 53), as described above in conjunction with FIG. 14A or 14B, and to set the entire region of the other of the image regions 53 and 54 (for example, the image region 54) as the ROI.

According to the Max Shift described above, the wavelet coefficients of the ROI are subjected to a bit-shift towards the upper bits (significant bits) before being encoded. Hence, it is possible to reproduce only the image of the image region, which is set as the ROI, by expanding only the codes of the upper bit-planes (significant bit-planes) of the encoded data. Moreover, by extracting only the codes of the upper bit-planes of the encoded data and recomposing the codes, it is possible to easily convert the encoded data to encoded data consisting solely of the codes of the image region that is set as to the ROI.

The image processing apparatus 200 inputs the encoded data of the image having a certain size and a certain aspect ratio which is 4:3, for example, from the encoded data source 201. The image processing apparatus 200 generates the encoded data suited for displaying a screen or, a window in the screen, with the size and aspect ratio that are set, as described above for the image processing apparatus 100. The set aspect ratio may be 16:9, for example. In the image processing apparatus 200, however, the encoded data that is input is not subjected to an expansion and a compression, and the image processing apparatus 200 generates the encoded data by a conversion process carried out in the coded state.

The image processing apparatus 400 obtains the encoded data of the image that has been processed in the image processing apparatus 100 or 200, via the storage 300. The image processing apparatus 400 converts the encoded data obtained via the storage 300 into encoded data consisting solely of the codes of the image region having the aspect ratio and size of the screens of the external devices 401 and 402, and transmits the converted encoded data to the external devices 401 and 402 via a cable or wireless transmission path or network. The image processing apparatus 500 obtains the encoded data of the image stored in the storage 300, and expands only the codes of the image region having the aspect ratio and size of the screens of the display units 501 and 502 or the aspect ratio and size of a window in the screen to reproduce the image data. The image processing apparatus 500 transmits the reproduced image data to the display units 501 and 502.

Next, a more detailed description will be given with respect to the image processing apparatuses 100, 200, 400 and 500.

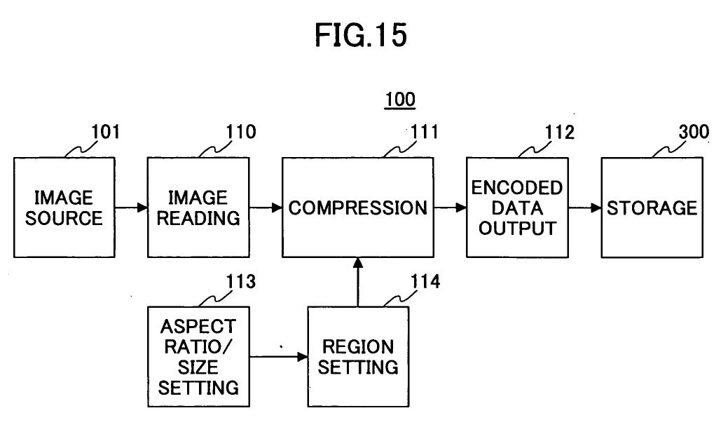

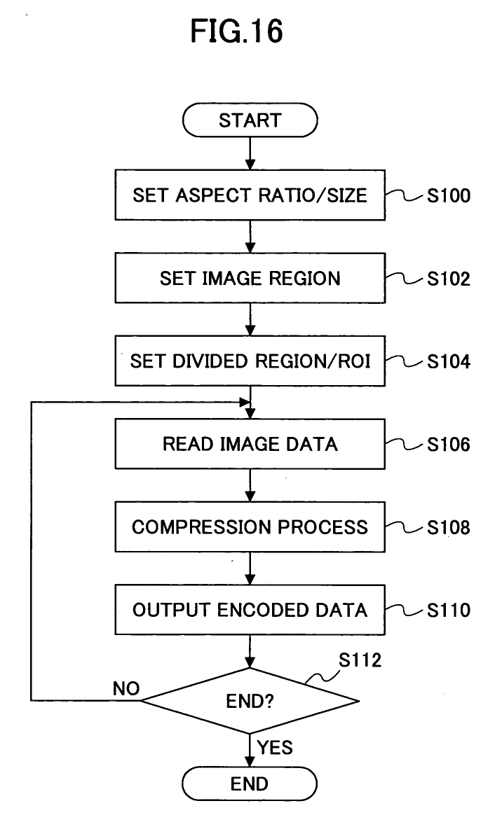

The image processing apparatus 100 has a structure shown in FIG. 15 and operates as shown in FIG. 16. FIG. 15 is a system block diagram showing the structure of the image processing apparatus 100, and FIG. 16 is a flow chart for illustrating the operation of the image processing apparatus 100.

As shown in FIG. 15, the image processing apparatus 100 includes an image reading unit 110, a compression unit 111, an encoded data output unit 112, an aspect ratio and size setting unit 113, and a region setting unit 114.

In FIG. 16, the aspect ratio and size setting unit 113 sets one or more aspect ratios and/or sizes, in a step S100. The region setting unit 114 sets one or more image regions having the set aspect ratio and/or size, as described above in conjunction with FIGS. 11A through 11D, in a step S102. The region setting unit 114 then sets the divided regions (tiles, precincts or code blocks) of the compression process so that the boundaries of the divided regions match the boundaries of the image region or, sets one image region as the ROI of the compression process, as described above in conjunction with FIGS. 12A through 14B, in a step S104.

The image reading unit 110 reads one image data from the image source 101 in a step S106, and the read image data is input to the compression unit 111. The compression unit 111 carries out a compression process with respect to the image data, according to the divided regions or the ROI set by the region setting unit 114, in a step S108, and the encoded data generated by the compression process is input to the encoded data output unit 112. The encoded data output unit 112 outputs the encoded data to the storage 300 in a step S110. A step S112 decides whether or not the processing of the last image data has ended, and the process returns to the step S106 if the decision result is NO. In other words, the steps S106 through S110 are repeated, so that the image data input from the image source 101 are successively subjected to the compression process, and the encoded data generated by the compression process are stored in the storage 300. The process ends if the decision result in the step S112 is YES. The decision result in the step S112 becomes YES also when an external instruction is input to the image processing apparatus 100 from an instructing unit or (part not shown).

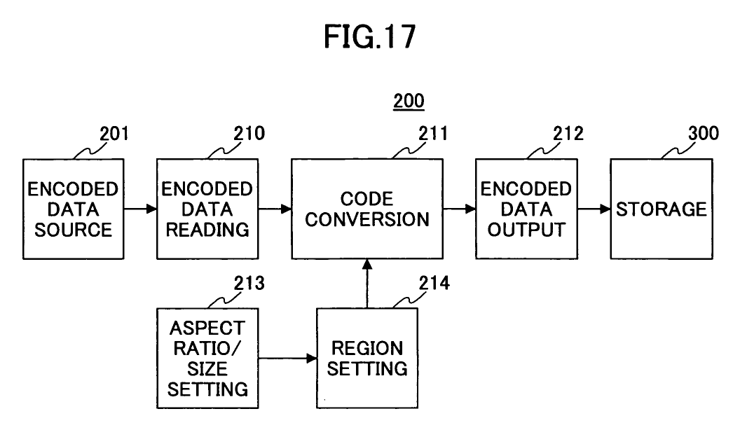

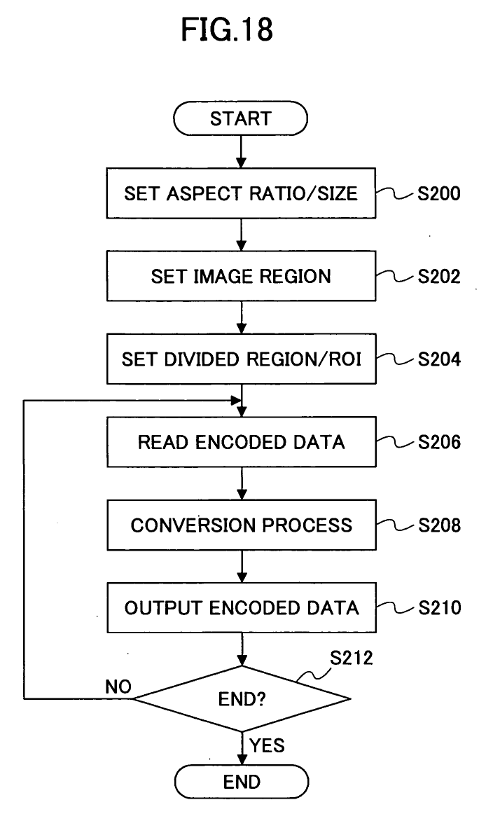

The image processing apparatus 200 has a structure shown in FIG. 17 and operates as shown in FIG. 18. FIG. 17 is a system block diagram showing the structure of the image processing apparatus 200, and FIG. 18 is a flow chart for illustrating the operation of the image processing apparatus 200.

As shown in FIG. 17, the image processing apparatus 200 includes an encoded data reading unit 210, a code conversion unit 211, an encoded data output unit 212, an aspect ratio and size setting unit 213, and a region setting unit 214.

In FIG. 18, the aspect ratio and size setting unit 213 sets one or more aspect ratios and/or sizes, in a step S200. The region setting unit 214 sets one or more image regions having the set aspect ratio and/or size, as described above in conjunction with FIGS. 11A through 11D, in a step S202. The region setting unit 214 then sets the divided regions (tiles, precincts or code blocks) of the compression process so that the boundaries of the divided regions match the boundaries of the image region or; sets one image region as the ROI of the compression process, as described above in conjunction with FIGS. 12A through 14B, in a step S204.

The encoded data reading unit 210 reads encoded data of one image data from the encoded data source 201 in a step S206, and the read encoded data is input to the code conversion unit 211. The code conversion unit 211 carries out a conversion process with respect to the encoded data, according to the divided regions or the ROI set by the region setting unit 214, in a step S208, and generates encoded data which are the same as the encoded data obtained by compressing the original image data according to the set divided regions or ROI. The encoded data generated by the conversion process is input to the encoded data output unit 212. The encoded data output unit 212 outputs the encoded data to the storage 300 in a step S210. A step S212 decides whether or not the processing of the last encoded data has ended, and the process returns to the step S206 if the decision result is NO. In other words, the steps S206 through S210 are repeated, so that the encoded data input from the encoded data source 201 are successively subjected to the conversion process, and the encoded data generated by the conversion process are stored in the storage 300. The process ends if the decision result in the step S212 is YES. The decision result in the step S212 becomes YES also when an external instruction is input to the image processing apparatus 200 from an instructing unit or (part not shown).

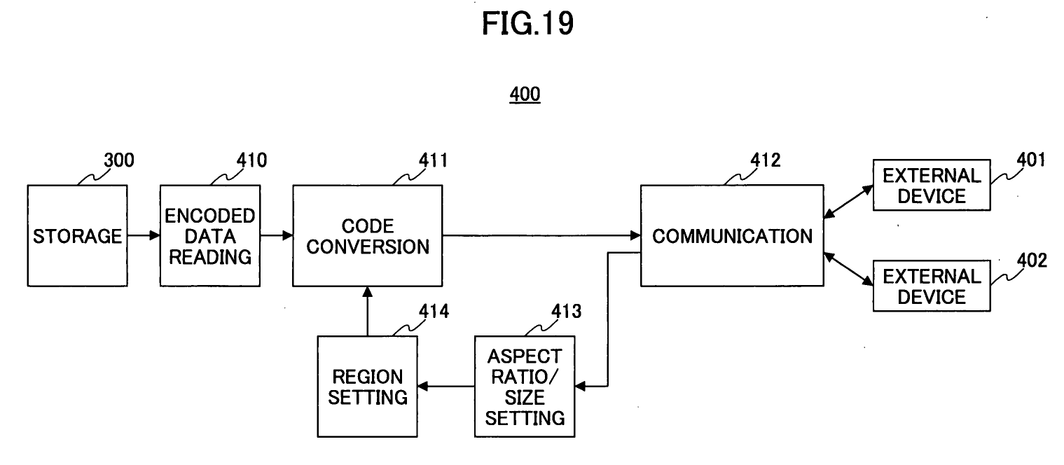

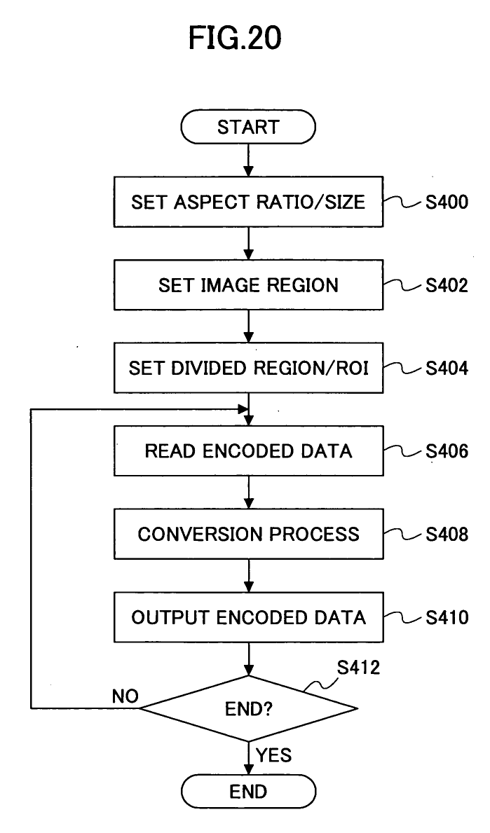

The image processing apparatus 400 has a structure shown in FIG. 19 and operates as shown in FIG. 20. FIG. 19 is a system block diagram showing the structure of the image processing apparatus 400, and FIG. 20 is a flow chart for illustrating the operation of the image processing apparatus 400.

As shown in FIG. 19, the image processing apparatus 400 includes an encoded data reading unit 410, a code conversion unit 411, a communication unit 412, an aspect ratio and size setting unit 413, and a region setting unit 414.

An aspect ratio and/or size specifying information corresponding to the screen of the external device 401 (or 402) is transmitted from the external device 401 (or 402) which accepts an image transmission request, and the communication unit 412 receives the aspect ratio and/or size specifying information, by a procedure which is not shown in FIG. 20. The external device 401 (or 402) thus functions as a transmission request source.

In FIG. 20, the aspect ratio and size setting unit 413 sets the aspect ratio and/or size according to the aspect ratio and/or size specifying information, in a step S400. The aspect ratio and/or size, which are set by the aspect ratio and size setting unit 413, must match the aspect ratio and/or size which is set by the image processing apparatus 100 or 200. In other words, the aspect ratio and/or size which have a possibility of being set in the image processing apparatus 400 is set in the image processing apparatus 100 or 200.

The region setting unit 414 sets one or more image regions having the set aspect ratio and/or size, as described above in conjunction with FIGS. 11A through 11D, in a step S402. The image region that is set may be the entire original image. The region setting unit 414 then sets the divided regions (tiles, precincts or code blocks) of the compression process so that the boundaries of the divided regions match the boundaries of the image region or, sets one image region as the ROI of the compression process, as described above in conjunction with FIGS. 12A through 14B, in a step S404.

The encoded data reading unit 410 reads encoded data of the image requested by the image transmission request, from the storage 300, in a step S406, and the read encoded data is input to the code conversion unit 411. The code conversion unit 411 carries out a conversion process with respect to the encoded data, according to the information of the image region set by the region setting unit 414, in a step S408. More particularly, the code conversion unit 411 extracts only the codes of the divided regions (tiles, precincts or code blocks) included in the set image region, and recomposes the encoded data from the extracted codes. In the case of the encoded data having the image region set as the ROI, the code conversion unit 411 extracts only the codes of the upper bit-planes (significant bit-planes), and recomposes the encoded data from the extracted codes. The encoded data generated by the conversion process is input to the communication unit 412. The communication unit 412 transmits the encoded data to the transmission request source, that is, the external device 401 (or 402), in a step S410.

A step S412 decides whether or not the processing of the last encoded data has ended, and the process returns to the step S406 if the decision result is NO. In other words, the steps S406 through S410 are repeated, so that the encoded data of the image requested by the transmission request source are successively converted and transmitted to the transmission request source. The process ends if the decision result in the step S412 is YES. The decision result in the step S412 becomes YES also when an external end instruction is input to the image processing apparatus 400 from the transmission request source.

Therefore, the encoded data including only the necessary codes is transmitted to the device at the transmission request source depending on the aspect ratio and/or size of the screen of the device at the transmission request source. For this reason, the device at the transmission request source efficiently reproduce and display the image by expanding the received encoded data, without having to carry out additional processes such as adjustment of the image size. In addition, since only the codes necessary for the display are transmitted and received, it is possible to avoid an increase in the processing time required for the transmission and reception, because unnecessary codes are not transmitted and received. Moreover, because the encoded data stored in the storage 300 is transmitted to the device at the transmission request source after converting the encoded data into the encoded data which suits the aspect ratio and/or size of the screen of the device at the transmission request source, it is unnecessary to store encoded data of the image for various aspect ratios and/or sizes in the storage 300, thereby improving the utilization efficiency of the storage 300.

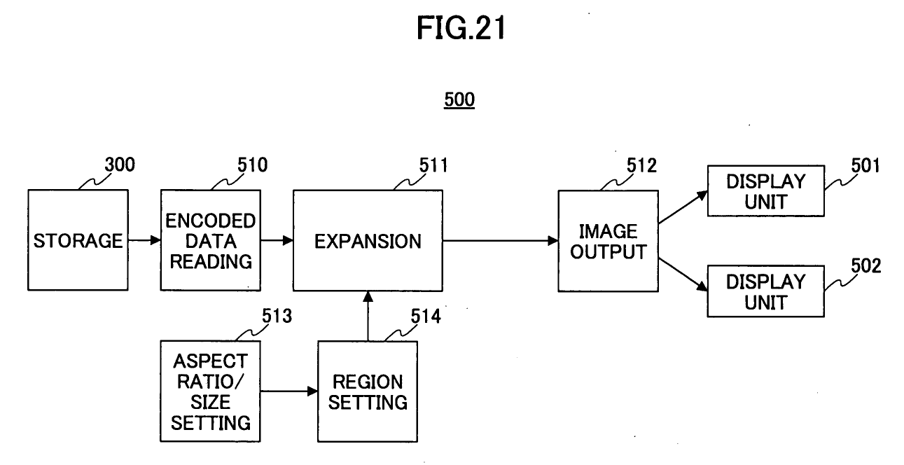

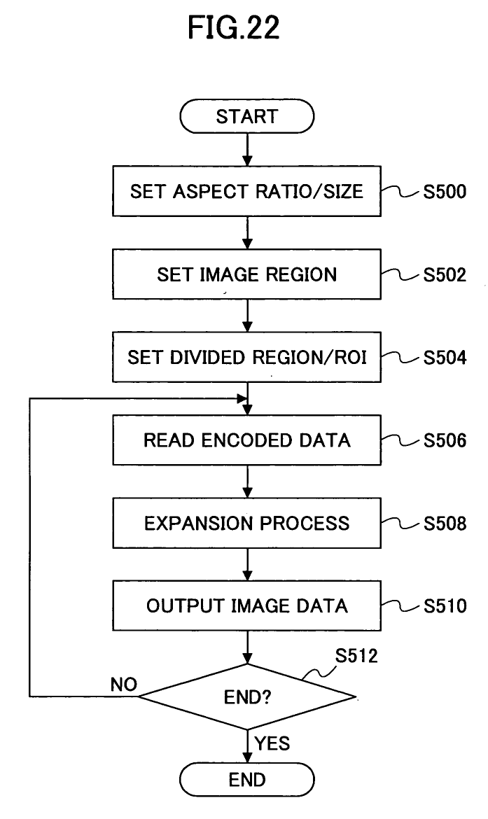

The image processing apparatus 500 has a structure shown in FIG. 21 and operates as shown in FIG. 22. FIG. 21 is a system block diagram showing the structure of the image processing apparatus 500, and FIG. 22 is a flow chart for illustrating the operation of the image processing apparatus 500.

As shown in FIG. 21, the image processing apparatus 500 includes an encoded data reading unit 510, an expansion unit 511, an image output unit 512, an aspect ratio and size setting unit 513, and a region setting unit 514.

In FIG. 22, the aspect ratio and size setting unit 513 sets the aspect ratio and/or size corresponding to the screen or, the window in the screen of the display unit 501 (or 502), which is to display the image, in a step S500. The aspect ratio and/or size which are set by the aspect ratio and size setting unit 513 must match the aspect ratio and/or size which is set by the image processing apparatus 100 or 200. In other words, the aspect ratio and/or size which have a possibility of being set in the image processing apparatus 500 is set in the image processing apparatus 100 or 200.

The region setting unit 514 sets one or more image regions having the set aspect ratio and/or size, as described above in conjunction with FIGS. 11A through 11D, in a step S502. The image region that is set may be the entire original image. The region setting unit 514 then sets the divided regions (tiles, precincts or code blocks) of the compression process so that the boundaries of the divided regions match the boundaries of the image region or, sets one image region as the ROI of the compression process, as described above in conjunction with FIGS. 12A through 14B, in a step S504.

The encoded data reading unit 510 reads encoded data of the image from the storage 300, in a step S506, and the read encoded data is input to the expansion unit 511. The expansion unit 511 expands only the codes of the set image region of the read encoded data, to generate reproduced image data, in a step S508. More particularly, only the codes of the divided regions (tiles, precincts or block codes) included in the set image region are expanded. In the case of the encoded data having the image region processed as the ROI, only the codes of the upper bit-planes (significant bit-planes) are expanded. The reproduced image data generated by the expansion process is output to the display unit 501 (or 502), in a step S510.

A step S512 decides whether or not the processing of the last encoded data has ended, and the process returns to the step S506 if the decision result is NO. In other words, the steps S506 through S510 are repeated, so that the encoded data of the image stored in the storage 300 are successively expanded and displayed. The process ends if the decision result in the step S512 is YES. The decision result in the step S512 becomes YES also when an external end instruction is input to the image processing apparatus 500 from an instructing unit or (part not shown).

Therefore, only the codes of the necessary region of the original image is expanded depending on the aspect ratio and/or size of the screen of the display unit, in order to reproduce and display the image. For this reason, the display unit does not need to carry out additional processes such as adjustment of the image size. In addition, since the codes of the image region that does not need to be displayed are not subjected to the expansion process in the image processing apparatus 500, it is possible improve the processing efficiency. Moreover, because it is unnecessary to store encoded data of the image for various aspect ratios and/or sizes in the storage 300, it is possible to improve the utilization efficiency of the storage 300.

According to one embodiment of the present invention, the image processing apparatus may be formed by any of the image processing apparatuses 100, 200, 400 and 500 described above. Further, an embodiment of the image processing apparatus according to the present invention may be realized by any of the image processing apparatuses 100, 200, 400 and 500 and the image processing system including the image processing apparatuses 100, 200, 400 and 500.

Each of the image processing apparatuses 100, 200, 400 and 500 and the image processing system which includes the image processing apparatuses 100, 200, 400 and 500 can be realized by software on a general purpose computer such as a personal computer. In other words, the functions of each of the image processing apparatuses 100, 200, 400 and 500 may be realized by executing a program which causes the computer to perform the procedures of the image processing described above by utilizing hardware resources of the computer. An embodiment of the computer-readable storage medium according to the present invention stores such a program.

The computer-readable storage medium may be formed by any type of recording media capable storing the computer in a computer-readable manner. For example, the recording medium forming the computer-readable storage medium may be selected from semiconductor memory devices, magnetic recording media, optical recording media and magneto-optic recording media.

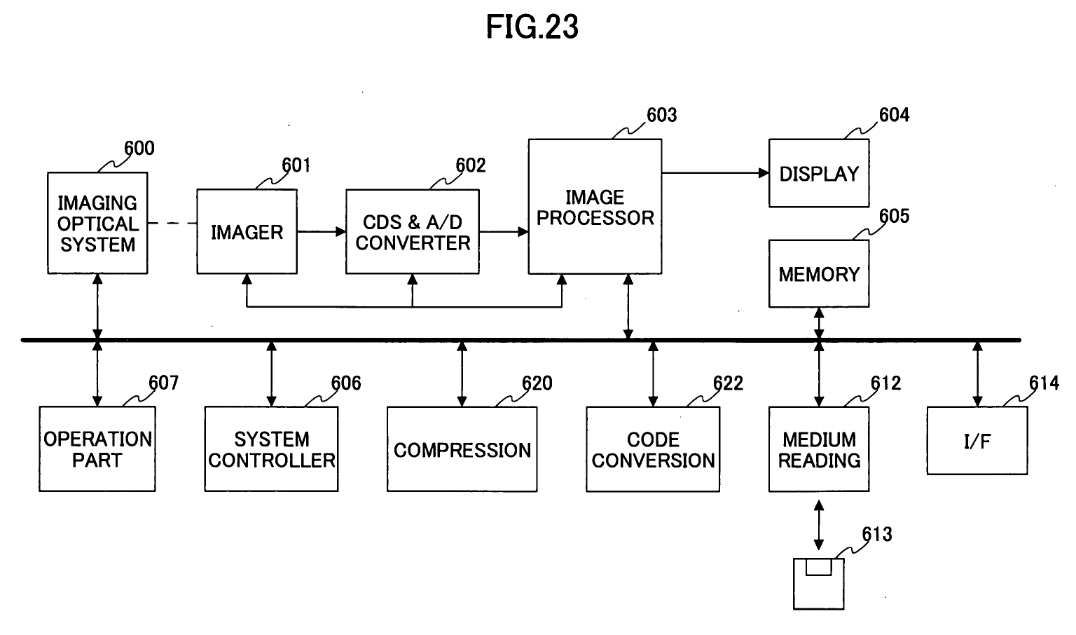

Next, a description will be given of an embodiment of the electronic camera according to the present invention, by referring to FIG. 23. FIG. 23 is a system block diagram showing this embodiment of the electronic camera. This embodiment of the electronic camera is characterized in that the electronic camera includes the functions of the image processing apparatus 100 and/or 200 described above, in addition to basic functions of a general electronic camera such as a digital still camera and a digital video camera.

In FIG. 23, an imaging optical system 600 has a generally known structure including an optical lens, a stopper mechanism, a shutter mechanism, a zoom mechanism and the like. A CCD or MOS type imager 601 subjects an optical image imaged by the imaging optical system 600 to a color separation, and converts the separated color components into electrical signals depending amounts of light. A Correlation Double Sampling (CDS) and Analog-to-Digital (A/D) converter 602 samples output signals of the imager 601 and converts the output signals into digital signals (image data). The CDS A/D converter 602 includes a Correlation Double Sampling (CDS) circuit and an Analog-to-Digital (A/D) converter circuit.

For example, an image processor 603 may be formed by a high-speed Digital Signal Processor (DSP) that is controlled by programs (microcodes). The image processor 603 carries out a signal processing such as an enhancement process including a gamma correction process, a white balance process and an edge emphasis process, with respect to the image data that is input from the CDS and A/D converter 602. In addition, the image processor 603 also controls the imager 601, the CDS and A/D converter 602 and a display unit 604. Furthermore, the image processor 603 detects information that is used to carry out processes such as an automatic focusing, an automatic exposure control and a white balance adjustment. For example, the display unit 604 may be formed by a Liquid Crystal Display (LCD). The display unit 604 is used to display a monitoring image (through image), an image that is picked up (that is, imaged), and other information.

The imaging optical system 600, the imager 601, the CDS and A/D converter 602 and the image processor 603 form an imaging unit or part for imaging a still image or a dynamic image.

A compression unit 620 corresponds to the compression unit 111 shown in FIG. 15, and a code conversion unit 622 corresponds to the code conversion unit 211 shown in FIG. 17.

A medium recording unit 612 forms a write and/or read unit or part for writing information on and/or reading information from a recording (storage) medium 613. For example, the recording medium 613 may be formed by any of various kinds of memory cards. An interface unit 614 provides an interface of the electronic camera, so that the electronic camera may exchange information with an external device, such as a personal computer, via a cable and/or wireless transmission path or network.

For example, a system controller 606 is formed by a microcomputer. The system controller 606 controls the stopper mechanism, the shutter mechanism and the zooming mechanism of the imaging optical system 600, the image processor 603, the compression unit 620, the code conversion unit 622 and the medium recording unit 612, in response to user operation information input from an operation unit 607, information input from the image processor 603 and the like. A memory 605 temporarily stores the image data and the encoded data thereof. The memory 605 is also used as a work region of the image processor 603, the system controller 606, the compression unit 620, the code conversion unit 622 and the medium recording unit 622. The operation unit 607 includes operation buttons and/or switches that are generally provided to operate the electronic camera, and also one or more operation buttons and/or switches for setting the aspect ratio and/or size.

The functions of the image processing apparatus 100 may be realized by the compression unit 602, the system controller 606 (programs running thereon), the medium recording unit 612 and the like of the electronic camera. The imaging unit or part of the electronic camera corresponds to the image source 101 shown in FIG. 15.

The functions of the image processing apparatus 200 may be realized by the code conversion unit 622, the system controller 606 (programs running thereon), the medium recording unit 612 and the like of the electronic camera. The recording medium 613 corresponds to the encoded data source 201 shown in FIG>17.

Of course, the functions of the compression unit 620 and the code conversion unit 622 may be realized by the system controller 606 or the image processor 603 by use of programs.

Next, a description will be given of the operation of the electronic camera.

When a imaging button of the operation unit 607 is pushed, an imaging instruction is supplied from the system controller 606 to the image processor 603, and the image processor 603 drives the imager 601 under conditions of the still image imaging or a dynamic image imaging. The image data of the picked up (imaged) image is temporarily stored in the memory 605 via the image processor 605. Normally, the image data is compressed by the compression unit 620 at a predetermined compression ratio or a default compression ratio, under the control of the system controller 606. The encoded data obtained by the compression unit 620 is recorded in the recording medium 613 by the medium recording unit 612.

When utilizing the functions of the image processing apparatus 100, the setting of the aspect ratio and/or size and the image region is carried out by the system controller 606, similarly as described above in conjunction with FIGS. 15 and 16, in response to an instruction from the operation unit 607. Then, the compression process of the compression unit 620 is carried out similarly to that of the compression unit 111 shown in FIG. 15, and the encoded data generated by the compression process is recorded in the recording medium 613.

When utilizing the functions of the image processing apparatus 200, the setting of the aspect ratio and/or size and the image region is carried out by the system controller 606, similarly as described above in conjunction with FIGS. 17 and 18, in response to an instruction from the operation unit 607. Thereafter, the encoded data recorded in the recording medium 613 is read, and the code conversion process of the code conversion unit 622 is carried out similarly to that of the code conversion unit 211 shown in FIG. 17, with respect to the read encoded data. The encoded data obtained by this code conversion process is recorded in the recording medium 613.

In the embodiments described heretofore, the present invention is applied to the JPEG2000. However, the compression algorithm of the present invention is of course not limited to the JPEG2000.

Further, the present invention is not limited to these embodiments, but various variations and modifications may be made without departing from the scope of the present invention.

What is claimed is

1. An image processing method comprising:
carrying out a compression process that divides an image into a plurality of divided regions and compresses the divided regions in a state where each of the divided regions are independent of one another; and
setting boundaries of the divided regions in order to approximately match boundaries of one or a plurality of image regions that are within the image and have aspect ratios and/or sizes different from those of the image.

2. The image processing method as claimed in claim 1, wherein the compression process employs a compression algorithm in conformance with JPEG2000, and wherein setting boundaries of the divided regions includes approximately matching boundaries of tiles, precincts or code blocks used in the compression process to the boundaries of the one or plurality of image regions which are within the image.

3. An image processing method comprising:
carrying out a compression process with respect to an image by employing a compression algorithm in conformance with JPEG2000; and
setting an image region that is within the image and has an aspect ratio and/or size different from those of the image, as a Region Of Interest (ROI).

4. An image processing method comprising:
obtaining encoded data that has been compressed by dividing an image into a plurality of divided regions and compressing the divided regions in a state where each of the divided regions are independent of one another; and
converting the encoded data into converted encoded data so that boundaries of the divided regions of the encoded data approximately match boundaries of one or a plurality of image regions of the converted encoded data, wherein the image regions are within the image and have aspect ratios and/or sizes different from those of the image.

5. The image processing method as claimed in claim 4, wherein the compression process employs a compression algorithm in conformance with JPEG2000, and converting the encoded data includes approximately matching boundaries of tiles, precincts or code blocks used in the compression process of the encoded data to the boundaries of the one or plurality of image regions.

6. An image processing method comprising:
carrying out a conversion process with respect to encoded data of an image that has been compressed by employing a compression algorithm in conformance with JPEG2000; and
converting the encoded data into converted encoded data of an image region that is within the image and has an aspect ratio and/or size different from those of the image, as a Region Of Interest (ROI).

7. An image processing apparatus comprising:
a compression unit to carry out a compression process that divides an image into a plurality of divided regions and compresses the divided regions in a state where each of the divided regions are independent of one another;
a first setting unit to set aspect ratios and/or sizes; and
a second setting unit to set boundaries of the divided regions in order to approximately match boundaries of one or a plurality of image regions which are within the image and have aspect ratios and/or sizes set by the first setting unit.

8. The image processing apparatus as claimed in claim 7, wherein the compression unit carries out a compression process employing a compression algorithm in conformance with JPEG2000, and the second setting unit approximately matches boundaries of tiles, precincts or code blocks used in the compression process to the boundaries of the one or plurality of image regions which are within the image.

9. The image processing apparatus as claimed in claim 7, comprising:
a conversion unit to convert encoded data of the image into encoded data consisting solely of codes corresponding to the image regions.

10. The image processing apparatus as claimed in claim 7, comprising:
a communication unit to communicate with an external device, the first setting unit setting the aspect ratios and/or sizes according to information that specifies the aspect ratios and/or sizes and is received from the external device by the communication unit; and
a conversion unit to convert encoded data of the image into converted encoded data consisting solely of codes corresponding to the image regions,
said communication unit transmitting the converted encoded data to the external device.

11. The image processing apparatus as claimed in claim 7, comprising:
an expansion unit to expand encoded data of the image by expanding only codes corresponding to the image regions.

12. An image processing apparatus comprising:
a compression unit to carry out a compression process with respect to an image by employing a compression algorithm in conformance with JPEG2000;
a first setting unit to set an aspect ratio and/or size; and
a second setting unit to set an image region that is within the image and has the aspect ratio and/or size set by the first setting unit, as a Region Of Interest (ROI).

13. The image processing apparatus as claimed in claim 12, comprising:
a conversion unit to convert encoded data of the image into encoded data consisting solely of codes corresponding to the image regions.

14. The image processing apparatus as claimed in claim 12, comprising:
a communication unit to communicate with an external device, the first setting unit setting the aspect ratio and/or size according to information that specifies the aspect ratio and/or size and is received from the external device by the communication unit; and
a conversion unit to convert encoded data of the image into converted encoded data consisting solely of codes corresponding to the image regions,
said communication unit transmitting the converted encoded data to the external device.

15. The image processing apparatus as claimed in claim 12, comprising:
an expansion unit to expand encoded data of the image by expanding only codes corresponding to the image regions.

16. An image processing apparatus comprising:
an obtaining unit to obtain encoded data that has been compressed by dividing an image into a plurality of divided regions and compressing the divided regions in a state where each of the divided regions are independent of one another;
a first setting unit to set aspect ratios and/or sizes;
a second setting unit to set the divided regions so that boundaries of the divided regions approximately match boundaries of one or a plurality of image regions which are within the image and have the aspect ratios and/or sizes set by the first setting unit; and
a conversion unit to convert the encoded data into converted encoded data which has been compressed using the divided regions set by the second setting unit.

17. The image processing apparatus as claimed in claim 16, wherein a compression process carried out to obtain the encoded data employs a compression algorithm in conformance with JPEG2000, and the second setting unit sets the divided regions so that boundaries of tiles, precincts or code blocks used in the compression process of the encoded data approximately matches the boundaries of the one or plurality of image regions.

18. The image processing apparatus as claimed in claim 16, wherein said conversion unit converts the encoded data of the image into converted encoded data consisting solely of codes corresponding to the image regions.

19. The image processing apparatus as claimed in claim 16, comprising:
a communication unit to communicate with an external device, the first setting unit setting the aspect ratios and/or sizes according to information which specifies the aspect ratios and/or sizes and is received from the external device by the communication unit,
said conversion unit converting the encoded data of the image into converted encoded data consisting solely of codes corresponding to the image regions, and
said communication unit transmitting the converted encoded data to the external device.

20. The image processing apparatus as claimed in claim 16, comprising:
an expansion unit to expand the encoded data of the image by expanding only codes corresponding to the image regions.

21. An image processing apparatus comprising:
a conversion unit to carry out a conversion process with respect to encoded data of an image that has been compressed by employing a compression algorithm in conformance with JPEG2000;
a first setting unit to set an aspect ratio and/or size;
a second setting unit setting an image region that is within the image and has the aspect ratio and/or size set by the first setting unit, as a Region Of Interest (ROI), and
the conversion unit converting the encoded data into converted encoded data having the Region Of Interest (ROI).

22. The image processing apparatus as claimed in claim 21, wherein the conversion unit converts the encoded data of the image into converted encoded data consisting solely of codes corresponding to the image regions.

23. The image processing apparatus as claimed in claim 21, comprising:
a communication unit to communicate with an external device, the first setting unit setting the aspect ratios and/or sizes according to information which specifies the aspect ratios and/or sizes and is received from the external device by the communication unit,
the conversion unit converting the encoded data of the image into converted encoded data consisting solely of codes corresponding to the image regions, and
the communication unit transmitting the converted encoded data to the external device.

24. The image processing apparatus as claimed in claim 21, comprising:
an expansion unit to expand the encoded data of the image by expanding only codes corresponding to the image regions.

25. An electronic camera for picking up a still or dynamic image, comprising:
an imaging unit to pick up an image;
a compression unit to carry out a compression process which divides the image into a plurality of divided regions and compresses the divided regions in a state where each of the divided regions are independent of one another;
a first setting unit to set aspect ratios and/or sizes; and
a second setting unit to set boundaries of the divided regions in order to approximately match boundaries of one or a plurality of image regions which are within the image and have aspect ratios and/or sizes set by the first setting unit.

26. An electronic camera for picking up a still or dynamic image, comprising:
an imaging unit to pick up an image;
a compression unit to carry out a compression process with respect to the image by employing a compression algorithm in conformance with JPEG2000;
a first setting unit to set an aspect ratio and/or size; and
a second setting unit to set an image region that is within the image and has the aspect ratio and/or size set by the first setting unit, as a Region Of Interest (ROI).

27. An electronic camera for picking up a still or dynamic image, comprising:
an imaging unit to pick up an image;
an obtaining unit to obtain encoded data which has been compressed by dividing the image into a plurality of divided regions and compressing the divided regions in a state where each of the divided regions are independent of one another;
a first setting unit to set aspect ratios and/or sizes;
a second setting unit to set the divided regions so that boundaries of the divided regions approximately match boundaries of one or a plurality of image regions which are within the image and have the aspect ratios and/or sizes set by the first setting unit; and
a conversion unit to convert the encoded data into converted encoded data that has been compressed using the divided regions set by the second setting unit.

28. An electronic camera for picking up a still or dynamic image, comprising:
an imaging unit to pick up an image;
a conversion unit to carry out a conversion process with respect to encoded data of the image that has been compressed by employing a compression algorithm in conformance with JPEG2000;
a first setting unit to set an aspect ratio and/or size;
a second setting unit setting an image region that is within the image and has the aspect ratio and/or size set by the first setting unit, as a Region Of Interest (ROI), and
the conversion unit converting the encoded data into converted encoded data having the Region Of Interest (ROI).

29. An article of manufacture comprising one or more recordable media having instructions stored thereon which, when executed by a computer, cause the computer to perform an image processing method comprising:
causing the computer to carry out a compression process which divides an image into a plurality of divided regions and compresses the divided regions in a state where each of the divided regions are independent of one another; and
causing the computer to set boundaries of the divided regions in order to approximately match boundaries of one or a plurality of image regions which are within the image and have aspect ratios and/or sizes different from those of the image.

30. The article of manufacture as claimed in claim 29, wherein causing the computer to carry out a compression process causes the computer to carry out the compression process which employs a compression algorithm in conformance with JPEG2000, and the setting procedure causes the computer to approximately match boundaries of tiles, precincts or code blocks used in the compression process to the boundaries of the one or plurality of image regions which are within the image.

31. An article of manufacture comprising one ore more recordable media having instructions stored thereon which, when executed by a computer, cause the computer to perform an image processing method comprising:
performing a compression process with respect to an image by employing a compression algorithm in conformance with JPEG2000; and
setting an image region that is within the image and has an aspect ratio and/or size different from those of the image, as a Region Of Interest (ROI).

32. An article of manufacture comprising one ore more recordable media having instructions stored thereon which, when executed by a computer, cause the computer to perform an image processing method comprising:
causing the computer to obtain encoded data which has been compressed by dividing an image into a plurality of divided regions and compressing the divided regions in a state where each of the divided regions are independent of one another; and
causing the computer to convert the encoded data into converted encoded data so that boundaries of the divided regions of the encoded data approximately match boundaries of one or a plurality of image regions of the converted encoded data, wherein the image regions are within the image and have aspect ratios and/or sizes different from those of the image.

33. The article of manufacture as claimed in claim 32, wherein the compression procedure causes the computer to perform the compression process which employs a compression algorithm in conformance with JPEG2000, and the conversion procedure causes the computer to approximately match boundaries of tiles, precincts or code blocks used in the compression process of the encoded data to the boundaries of the one or plurality of image regions.

34. An article of manufacture comprising one or more recordable media having instructions stored thereon which, when executed by a computer, cause the to perform an image processing method comprising:
carrying out a conversion process with respect to encoded data of an image that has been compressed by employing a compression algorithm in conformance with JPEG2000; and
converting the encoded data into converted encoded data of an image region that is within the image and has an aspect ratio and/or size different from those of the image, as a Region Of Interest (ROI).
